(19) United States
(12) Patent Application Publication
(10) Pub. No.: US 2026/0322143 A1
(43) Pub. Date: Oct. 15, 2026

(54) CHARGE AND DISCHARGE CONTROL CIRCUIT FOR CONTROLLING CHARGING AND DISCHARGING OF BATTERY

(71) Applicant: NISSHINBO MICRO DEVICES INC., Tokyo (JP)

(72) Inventor: Takayasu Yoshikawa, Tokyo (JP)

(21) Appl. No.: 19/563,555

(22) Filed: Mar. 11, 2026

(30) Foreign Application Priority Data
Mar. 26, 2025 (JP) 2025-052307
Nov. 26, 2025 (JP) 2025-203612

(51) Int. Cl. H02J 7/63; H02J 7/80; H02J 7/90

(52) U.S. Cl. CPC H02J 7/63; H02J 7/80; H02J 7/933

(57) ABSTRACT

A charge and discharge control circuit for preventing malfunction at power-on of the input power supply voltage includes: a detection circuit that generates a POR detection signal based on the power supply voltage, the detection circuit generating the POR detection signal having a first value for a first time interval based on detection of power-on of the power supply voltage, and generating the POR detection signal having a second value after the first time interval has elapsed; a counter circuit that is initialized based on the POR detection signal having the first value, the counter circuit measuring a second time interval based on the POR detection signal having the second value; and a control circuit configured to hold a first switch and a second switch for controlling discharging and charging of a secondary battery, in respective predetermined initial states during the first and second time intervals.

### CROSS REFERENCE TO RELATED APPLICATION

This application claims benefit of priority to Japanese Patent Application 2025-052307, filed Mar. 26, 2025, and of priority to Japanese Patent Application 2025-203612, filed Nov. 26, 2025, the entire content of which are incorporated herein by reference.

### TECHNICAL FIELD

The present [symbol] controlling charging and [symbol] and discharge control method, and a battery device.

### BACKGROUND ART

In general, a battery device for a secondary battery includes a secondary battery and a charge and discharge control circuit, which is commonly called a protection circuit. The charge and discharge control circuit is configured to start charge and discharge control in an intended state at power-on of the power supply voltage by Power-on Reset (POR) control, for example, to prevent malfunction at power-on of the power supply voltage. For example, JP2005-151697A discloses technology related to a processing circuit that executes processing including protection against abnormalities in a secondary battery.

### SUMMARY

In conventional charge and discharge control circuits, when protecting a secondary battery by POR control at power-on of the power supply voltage, the protection function for the secondary battery may malfunction due to, for example, the voltage value of the power supply voltage or the time required for the power supply voltage to increase.

An object of the present disclosure is to provide a charge and discharge control circuit, a charge and discharge control method, and a battery device that suppresses malfunction of a protection function for a secondary battery at power-on of the power supply voltage, as compared with conventional techniques.

A charge and discharge control circuit according to one aspect of the present disclosure for preventing malfunction at power-on of an input power supply voltage includes: a first detection circuit that generates a POR detection signal based on the power supply voltage, the first detection circuit generating the POR detection signal having a first value for a first time interval based on detection of power-on of the power supply voltage, and generating the POR detection signal having a second value after the first time interval has elapsed; a counter circuit that is initialized based on the POR detection signal having the first value, the counter circuit measuring a second time interval based on the POR detection signal having the second value; and a control circuit configured to hold a first switch for controlling discharging of a secondary battery that outputs the power supply voltage and a second switch for controlling charging of the secondary battery, in respective predetermined initial states during the first time interval and the second time interval.

According to the present disclosure, it is possible to provide a charge and discharge control circuit, a charge and discharge control method, and a battery device that suppresses malfunction of a protection function for a secondary battery at power-on of the power supply voltage, as compared with conventional techniques.

### BRIEF DESCRIPTION OF DRAWINGS

FIG. 1 is a schematic diagram of a battery device according to a first embodiment;

FIG. 2 is a schematic diagram of a POR detection circuit according to the first embodiment;

FIG. 3 is a timing chart illustrating an example of the operation of the POR detection circuit;

FIG. 4 is a schematic diagram of a counter circuit according to the first embodiment;

FIG. 5 is a schematic diagram of a short-circuit detection circuit according to the first embodiment;

FIG. 6 is a flowchart illustrating an example of the operation of a charge and discharge control circuit according to the first embodiment;

FIG. 7 is a timing chart illustrating an example of the operation of the charge and discharge control circuit according to the first embodiment;

FIG. 8A is a timing chart illustrating an example of the operation of the counter circuit according to the first embodiment;

FIG. 8B is a schematic diagram illustrating an example of a time setting method for a time setting circuit according to the first embodiment;

FIG. 9 is a timing chart illustrating another example of the operation of the charge and discharge control circuit according to the first embodiment;

FIG. 10 is a schematic diagram of a battery device according to a comparative example;

FIG. 11 is a flowchart illustrating an example of the operation of a charge and discharge control circuit according to the comparative example;

FIG. 12 is a timing chart illustrating an example of the operation of the charge and discharge control circuit according to the comparative example;

FIG. 13 is a timing chart illustrating another example of the operation of the charge and discharge control circuit according to the comparative example;

FIG. 14 is a schematic diagram of a battery device according to a second embodiment;

FIG. 15 is a timing chart illustrating an example of the operation of a charge and discharge control circuit according to the second embodiment;

FIG. 16 is a schematic diagram of a battery device according to a third embodiment; and

FIG. 17 is a timing chart illustrating an example of the operation of a charge and discharge control circuit according to the third embodiment.

### DETAILED DESCRIPTION

Hereinafter, embodiments according to the present disclosure will be described with reference to the drawings. The configurations described below are merely examples of the present disclosure, and the present disclosure is not limited to the following embodiments. The technology in the present disclosure is not limited thereto, and various modifications, replacements, additions, omissions, etc. can be made according to designs, etc. without departing from the technical ideas according to the present disclosure even in a case other than these embodiments.

Although the present disclosure has been fully described in connection with the preferred embodiments with reference to the accompanying drawings, various variations and modifications will be apparent to those skilled in the art. Such variations and modifications should be understood to be included within the scope of the present disclosure according to the appended claims as long as they do not depart from the scope of the present disclosure.

In the present disclosure, when describing comparative examples, modifications, or embodiments, differences from a first embodiment will be mainly described. In this case, in a comparative example, a modification, or another embodiment, the same or equivalent components as those of the first embodiment will be described with the same reference numerals. Furthermore, in the comparative examples, modifications, or other embodiments, descriptions overlapping with the first embodiment may be omitted. Features described in the modifications or embodiments may be combined with each other as long as they are not inconsistent.

In general, a battery device for a secondary battery includes a secondary battery, a charge and discharge control circuit having a protection function for protecting the secondary battery, for example, during charging or discharging, a discharge control transistor for controlling the discharging of the secondary battery, and a charge control transistor for controlling the charging of the secondary battery. The charge and discharge control circuit is configured to control the charging and discharging of the secondary battery by monitoring the state of the secondary battery and outputting control signals for switching the discharge control transistor and the charge control transistor on and off. The charge and discharge control circuit is configured to start charge and discharge control in an intended state at power-on of the power supply voltage using Power-on Reset (POR) control to prevent malfunctions at power-on of the power supply voltage. For example, when the charge and discharge control circuit detects power-on of the power supply voltage, it outputs control signals to hold the discharge control transistor and the charge control transistor in respective intended states for a certain time interval, thereby controlling the charge and discharge control to be performed in an intended state at power-on of the power supply voltage.

If the power supply voltage of the secondary battery at power-on is less than the threshold voltage for releasing the POR control, the POR control is not released. In this case, for example, the charge and discharge control circuit may be unable to turn off the discharge control transistor despite the need to protect the secondary battery from overdischarge. One possible method to prevent this situation is to set the threshold voltage less than the expected power supply voltage. However, if the threshold voltage is set to a low value, a short-circuit may be erroneously detected even when no short-circuit has actually occurred, causing the discharge control transistor to be turned off due to the malfunction. Thus, conventional charge and discharge control circuits may malfunction in their protection functions for the secondary battery due to voltage changes at power-on of the power supply voltage. To prevent such a malfunction, conventional charge and discharge control circuits are required to extend the certain time interval. To extend the certain time interval, it is necessary to increase the resistance of the resistor and the capacitance of the capacitor included in a circuit for detecting power-on of the charge and discharge control circuit. It is difficult for the charge and discharge control circuit to flexibly adjust the certain time interval in order to set an appropriate certain time interval for each configuration of the secondary battery.

A charge and discharge control circuit according to the present disclosure includes a detection circuit that detects power-on of the power supply voltage, a counter circuit that measures a predetermined time interval, and a control circuit that controls a discharge control transistor and a charge control transistor based on a predetermined signal. The detection circuit generates a predetermined detection signal for a predetermined time interval based on detection of power-on of the power supply voltage. The counter circuit measures the predetermined time interval based on a signal from the detection circuit. After detecting power-on of the power supply voltage, the control circuit holds the discharge control transistor and the charge control transistor in respective predetermined initial states until the predetermined time interval measured by the counter circuit has elapsed. With this configuration, the charge and discharge control circuit according to the present disclosure can prevent malfunction of a protection function for a secondary battery irrespective of voltage changes at power-on of the power supply voltage.

### First Embodiment

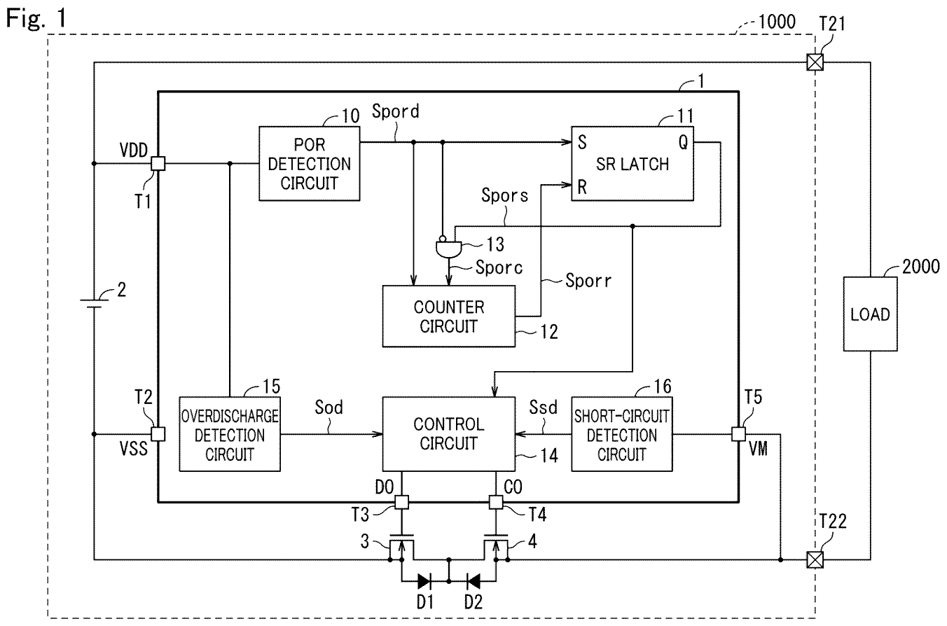

A battery device 1000 according to a first embodiment of the present disclosure will be described with reference to FIG. 1. FIG. 1 is a schematic diagram of the battery device 1000 according to the first embodiment of the present disclosure.

The battery device 1000 includes a charge and discharge control circuit 1, a secondary battery 2, a discharge control transistor 3, a charge control transistor 4, and an external positive terminal T21 and an external negative terminal T22 to which a load 2000 is connected. In the first embodiment, the discharge control transistor 3 and the charge control transistor 4 are N-type MOS transistors. The discharge control transistor 3 is an example of a first switch. The charge control transistor 4 is an example of a second switch. The discharge control transistor 3 and the charge control transistor 4 may be other switch elements, such as bipolar transistors, e.g., insulated gate bipolar transistors (IGBTs). Each MOS transistor described below may also be other switch elements such as bipolar transistors.

The external positive terminal T21 is connected to the external negative terminal T22 via the load 2000. The load 2000 includes at least one of a resistive load or a capacitive load. The resistive load refers to a device driven by a battery, for example, a CPU or a motor. The capacitive load refers to a capacitor capacitance, a capacitance obtained by summing all the parasitic capacitances of wiring or the like. The load 2000 may include a charger that charges the secondary battery.

The charge and discharge control circuit 1 includes a Power-on Reset (POR) detection circuit 10, an SR latch 11, a counter circuit 12, an AND circuit 13, a control circuit 14, an overdischarge detection circuit 15, and a short-circuit detection circuit 16. The charge and discharge control circuit 1 also includes a positive power supply terminal T1, a negative power supply terminal T2, a discharge control terminal T3, a charge control terminal T4, and an external negative electrode voltage input terminal T5.

The source of the discharge control transistor 3 is connected to the negative electrode of the secondary battery 2 and is grounded. The drain of the discharge control transistor 3 is connected to the drain of the charge control transistor 4. The gate of the discharge control transistor 3 is connected to the control circuit 14 via the discharge control terminal T3. A discharge control signal DO output from the control circuit 14 is applied to this gate. The source of the charge control transistor 4 is connected to the external negative terminal T22. The gate of the charge control transistor 4 is connected to the control circuit 14 via the charge control terminal T4. A charge control signal CO output from the control circuit 14 is applied to this gate. The discharge control transistor 3 has a parasitic diode DI, and the charge control transistor 4 has a parasitic diode D2. The discharge control transistor 3 is turned on and off by the discharge control signal DO applied to its gate from the control circuit 14. The charge control transistor 4 is turned on and off by the charge control signal CO applied to its gate from the control circuit 14.

The positive power supply terminal T1 is connected to the positive electrode of the secondary battery 2 and the external positive terminal T21. The negative power supply terminal T2 is connected to the negative electrode of the secondary battery 2. The external negative electrode voltage input terminal T5 is connected to the external negative terminal T22.

The POR detection circuit 10 generates a POR detection signal Spord based on a positive power supply voltage VDD and outputs the POR detection signal Spord to the SR latch 11, the counter circuit 12, and the AND circuit 13. When the positive power supply voltage VDD corresponding to the voltage at the positive power supply terminal T1 rises, the POR detection circuit 10 generates the POR detection signal Spord having a high level as an initial state. The POR detection circuit 10 compares the positive power supply voltage VDD with a POR release voltage Vpr, and if VDD is less than Vpr, continues to generate the POR detection signal Spord having a high level. The POR detection circuit 10 detects power-on of the positive power supply voltage VDD when VDD becomes greater than or equal to Vpr. The POR detection circuit 10 generates the POR detection signal Spord having a low level after a predetermined delay time Td1 has elapsed since the detection of power-on of the positive power supply voltage VDD. The predetermined delay time Td1 is an example of a first time interval. The high level of the POR detection signal Spord is an example of a first value, and the low level is an example of a second value. The negative power supply voltage VSS corresponding to the voltage at the negative power supply terminal T2 is supplied to each circuit in the charge and discharge control circuit 1, but is omitted from the block diagrams in FIG. 1 and subsequent figures. An external negative voltage VM at the external negative electrode voltage input terminal T5 corresponding to the voltage at the external negative terminal T22 is applied to the control circuit 14 as a reference voltage for the low level of the charge control signal CO, but is omitted from the block diagrams in FIG. 1 and subsequent figures. The rise of the positive power supply voltage VDD may be, for example, a rise of the positive power supply voltage VDD from 0 V to a voltage greater than 0 V due to the charge and discharge control circuit 1 and the secondary battery 2 being connected.

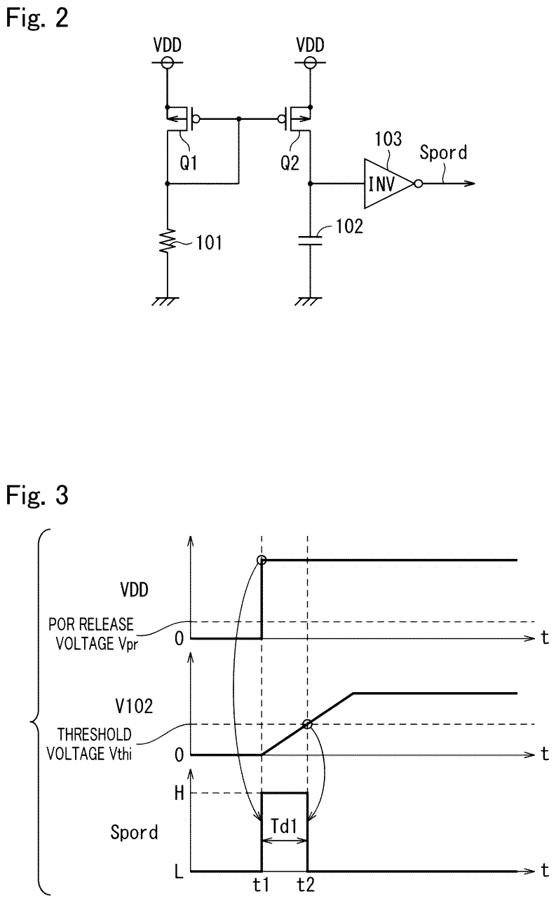

FIG. 2 is a schematic diagram of the POR detection circuit 10 according to the first embodiment The POR detection circuit 10 according to the first embodiment includes MOS transistors Q1 and Q2, a resistor 101, a capacitor 102, and a logic inverter 103. The resistor 101 may be a constant current source. The MOS transistors Q1 and Q2 are, for example, P-type MOS transistors. The positive power supply voltage VDD is applied to the sources of the MOS transistors Q1 and Q2. The gates of the MOS transistors Q1 and Q2 are connected to each other. The drain of the MOS transistor Q1 is connected to ground via the resistor 101. The connection point between the drain of the MOS transistor QI and the resistor 101 is connected to the connection point between the gate of the MOS transistor Q1 and the gate of the MOS transistor Q2. The drain of the MOS transistor Q2 is connected to ground via the capacitor 102. The connection point between the drain of the MOS transistor Q2 and the capacitor 102 is connected to the inverter 103. The inverter 103 inverts the voltage applied from the connection point and generates the POR detection signal Spord having a high level or a low level.

FIG. 3 is a timing chart illustrating an example of the operation of the POR detection circuit 10. The horizontal axis of FIG. 3 represents time. The vertical axes of FIG. 3 represent the positive power supply voltage VDD, a voltage V102 across the capacitor 102, and the level of the POR detection signal Spord, respectively.

At time t1, the positive power supply voltage VDD rises from 0 V to a predetermined voltage greater than the POR release voltage Vpr. The positive power supply voltage VDD rises, for example, when the secondary battery 2 is connected to the charge and discharge control circuit 1. The POR release voltage Vpr corresponds, for example, to the minimum operating voltage of the MOS transistors Q1 and Q2. When VDD becomes greater than or equal to Vpr, the MOS transistors Q1 and Q2 turn on. As a result, a current based on the positive power supply voltage VDD and the resistance of the resistor 101 flows through the MOS transistors Q1 and Q2, charging the capacitor 102. When the positive power supply voltage VDD rises, because the voltage V102 is less the threshold voltage Vthi, the inverter 103 generates the POR detection signal Spord having a high level from time t1 onwards.

At time t2, when the voltage V102 becomes greater than or equal to the threshold voltage Vthi due to charging of the capacitor 102, the inverter 103 generates the POR detection signal Spord having a low level. The threshold voltage Vthi corresponds to the inversion threshold voltage of the inverter 103. The delay time Td1 indicates the time interval from time t1 to time t2.

The SR latch 11 shown in FIG. 1 generates a POR state signal Spors based on the POR detection signal Spord and outputs the POR state signal Spors to the AND circuit 13 and the control circuit 14. The SR latch 11 generates a POR state signal Spors having a high level based on the POR detection signal Spord having a high level. The SR latch 11 latches the POR state signal Spors at a high level until the SR latch 11 receives a POR release signal Sporr having a high level, which will be described later. The SR latch II releases the latch based on the POR release signal Sporr having a high level and generates the POR state signal Spors having a low level. The SR latch 11 is an example of a state holding circuit. The high level of the POR state signal Spors is an example of a third value, and the low level is an example of a fourth value. In this way, after receiving the POR detection signal Spord having a high level, the SR latch Il holds the POR state signal Spors at a high level until receiving the POR release signal Sporr having a high level.

The counter circuit 12 generates the POR release signal Sporr and outputs the POR release signal Sporr to the SR latch 11. The counter circuit 12 is initialized based on a high-level POR detection signal Spord and measures a POR duration TI1 based on a low-level POR detection signal Spord. The POR duration TI1 is an example of a second time interval. Specifically, when the SR latch 11 generates the POR state signal Spors having a high level and the POR detection circuit 10 generates the POR detection signal Spord having a low level, the counter circuit 12 starts timing and counts the POR duration TI1. In the first embodiment, the POR release voltage Vpr is less than the minimum operating voltage of the counter circuit 12. The minimum operating voltage of the counter circuit 12 is less than an overdischarge detection voltage Vod, which will be described later. The POR release voltage Vpr is an example of the minimum operating voltage of the logic circuit included in the charge and discharge control circuit 1.

In the first embodiment, the counter circuit 12 measures the POR duration TI1 based on the POR duration measurement request Sporc having a high level from the AND circuit 13. The counter circuit 12 may be configured to measure the POR duration TI1 based on the POR detection signal Spord having a low level and the POR state signal Spors having a high level.

The counter circuit 12 generates the POR release signal Sporr having a high level after the POR duration TI1 has elapsed since the occurrence of the POR duration measurement request Sporc having a high level. The high level of the POR release signal Sporr is an example of a fifth value. The counter circuit 12 resets its timekeeping when the POR detection signal Spord having a high level is input.

In the first embodiment, the counter circuit 12 generates the POR release signal Sporr having a low level based on the POR duration measurement request Sporc having a low level from the AND circuit 13. The counter circuit 12 may be configured to stop time measurement when the POR detection signal Spord and the POR state signal Spors other than the combination of the POR detection signal Spord having a low level and the POR state signal Spors having a high level are input, and accordingly generate the POR release signal Sporr having a low level.

The AND circuit 13 generates the POR duration measurement request Spore having the level of the logical AND of the inverted value of the POR detection signal Spord and the POR state signal Spors, and outputs the POR duration measurement request Spore to the counter circuit 12. Specifically, when the POR detection signal Spord having a low level and the POR state signal Spors having a high level are input, the AND circuit 13 generates the POR duration measurement request Sporc having a high level, and in other cases generates the POR duration measurement request Sporc having a low level.

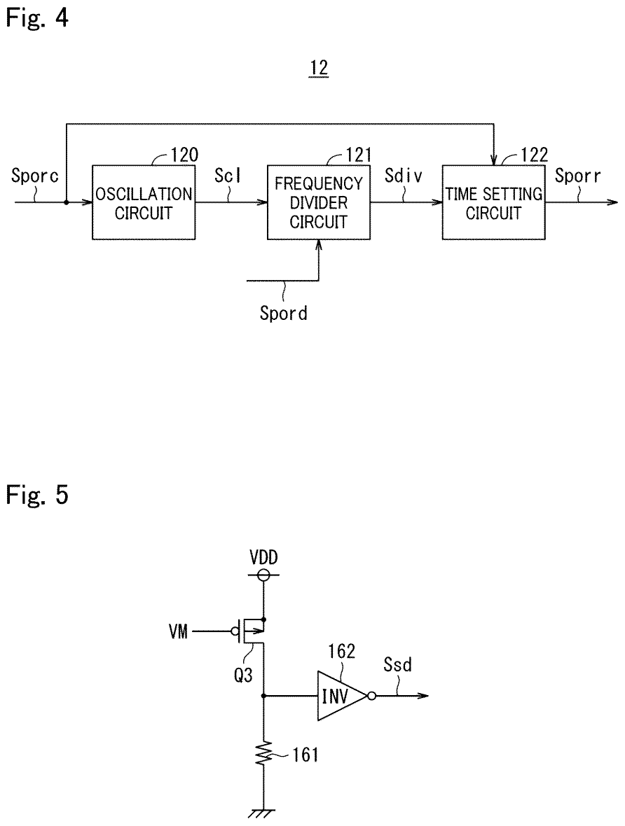

FIG. 4 is a schematic diagram of the counter circuit 12 according to the first embodiment. The counter circuit 12 according to the first embodiment includes an oscillation circuit 120, a frequency divider circuit 121, and a time setting circuit 122.

The oscillator circuit 120 generates a clock signal Scl based on the POR duration measurement request Sporc and outputs the clock signal Sel to the frequency divider circuit 121. When receiving the POR duration measurement request Sporc having a high level, the oscillator circuit 120 starts oscillating and switches the clock signal Scl between a high level and a low level at a predetermined period TI2, such as 0.25 ms. When receiving the POR duration measurement request Sporc having a low level, the oscillator circuit 120 stops the oscillation and generates the clock signal Scl having a low level.

The frequency divider circuit 121 generates a frequency-divided signal Sdiv based on the clock signal Scl and outputs the frequency-divided signal Sdiv to the time setting circuit 122. When receiving the oscillated clock signal Sel, the frequency divider circuit 121 generates n frequency-divided signals Sdiv by dividing the period TI2 of the clock signal Scl by up to 2ⁿ times, where n is a natural number. The n frequency-divided signals Sdiv include frequency-divided signals Sdiv1, Sdiv2, . . . Sdivn. In this specification, the n frequency-divided signals Sdiv1, Sdiv2, . . . Sdivn may also be referred. to as frequency-divided signals Sdiv. The frequency divider circuit 121 switches each frequency-divided signal Sdivn (n is a natural number) between high and low levels at a period 2ⁿ times the period TI2 of the clock signal Scl. The frequency divider circuit 121 also receives the POR detection signal Spord. When receiving the POR detection signal Spord having a high level, the frequency divider circuit 121 is initialized and generates the frequency-divided signal Sdiv having a low level. When the oscillation of the clock signal Scl stops, the frequency divider circuit 121 generates the frequency-divided signal Sdiv having a low level.

The time setting circuit 122 generates the POR release signal Sporr based on the frequency-divided signal Sdiv and the POR duration measurement request Sporc. When the time setting circuit 122 receives the POR duration measurement request Sporc having a high level and the frequency-divided signal Sdiv corresponding to a predetermined time setting corresponding to the POR duration TI1, the time setting circuit 122 generates the POR release signal Sporr having a high level. Then, when receiving the POR duration measurement request Spore having a low level, the time setting circuit 122 generates the POR release signal Sporr having a low level. In this manner, the counter circuit 12 times the preset POR duration TI1. The counter circuit 12 is not limited to the configuration shown in FIG. 4, and any counter circuit that times a predetermined time interval can be used. The POR duration TI1 can be easily changed using circuit switching method such as laser trimming. A method for setting the POR duration TI1 will be described later.

The control circuit 14 has one or more protection modes that control at least one of the discharge control transistor 3 or the charge control transistor 4 to a predetermined state based on an abnormality detection signal from an abnormality detection circuit such as the overdischarge detection circuit 15 or the short-circuit detection circuit 16. When the control circuit 14 receives the abnormality detection signal having a high level, the control circuit 14 switches from a mode, such as a normal mode, other than the protection mode to a predetermined protection mode. In this way, the charge and discharge control circuit 1 according to the first embodiment can provide protection against at least over-discharge and short-circuits as protection against abnormalities. The control circuit 14 is composed of predetermined circuit elements and logic circuits. The control circuit 14 may also be configured to include a processor such as a CPU and a storage that is a storage medium for storing arithmetic programs, data, and the like.

For example, the control circuit 14 transitions to the overdischarge protection mode after a predetermined delay time Td2 has elapsed based on an overdischarge detection signal Sod having a high level from the overdischarge detection circuit 15. Then, the control circuit 14 generates the discharge control signal DO having a low level to turn off the discharge control transistor 3, and controls the discharge control signal DO to hold the discharge control transistor 3 in an off state during the overdischarge protection mode.

For example, the control circuit 14 transitions to the short-circuit protection mode after a predetermined delay time Td3 has elapsed based on a short-circuit detection signal Ssd having a high level from the short-circuit detection circuit 16. Then, the control circuit 14 generates the discharge control signal DO having a low level to turn off the discharge control transistor 3, and controls the discharge control signal DO to hold the discharge control transistor 3 in an off state during the short-circuit protection mode.

Furthermore, the control circuit 14 initializes its control to a predetermined initial state based on the POR state signal Spors from the SR latch 11. For example, the control circuit 14 has an initialization mode in which at least one of the discharge control transistor 3 or the charge control transistor 4 is held in a predetermined initial state based on the POR state signal Spors. The control circuit 14 according to the first embodiment transitions to the initialization mode based on the POR state signal Spors having a high level. In the charge and discharge control circuit 1 according to the first embodiment, the predetermined initial states of the discharge control transistor 3 and the charge control transistor 4 are conducting states. The predetermined initial state of each of the discharge control transistor 3 and the charge control transistor 4 may be conducting states or open states. Upon transitioning to the initialization mode, the control circuit 14 controls at least one of the discharge control signal DO or the charge control signal CO to hold at least one of the discharge control transistor 3 or the charge control transistor 4 in the predetermined initial state. The control circuit 14 is configured to maintain the initialization mode without transitioning to the protection mode even when the control circuit 14 receives the abnormality detection signal during the initialization mode.

The overdischarge detection circuit 15 receives the positive power supply voltage VDD, generates the overdischarge detection signal Sod based on the positive power supply voltage VDD, and outputs the signal Sod to the control circuit 14. When the overdischarge detection circuit 15 detects that the positive power supply voltage VDD is less than the predetermined overdischarge detection voltage Vod, the overdischarge detection circuit 15 generates the overdischarge detection signal Sod having a high level. When the overdischarge detection circuit 15 detects that the positive power supply voltage VDD is greater than or equal to the overdischarge detection voltage Vod, the overdischarge detection circuit 15 generates the overdischarge detection signal Sod having a low level. The high level of the overdischarge detection signal Sod is an example of a sixth value. The overdischarge detection voltage Vod is an example of a predetermined threshold value.

The short-circuit detection circuit 16 receives the external negative voltage VM, generates the short-circuit detection signal Ssd based on the external negative voltage VM, and outputs the signal Ssd to the control circuit 14. When the short-circuit detection circuit 16 detects that the external negative voltage VM is greater than or equal to a predetermined short-circuit detection voltage Vsd, the short-circuit detection circuit 16 generates the short-circuit detection signal Ssd having a high level. When the short-circuit detection circuit 16 detects that the external negative voltage VM is less than the short-circuit detection voltage Vsd, the short-circuit detection circuit 16 generates the short-circuit detection signal Ssd having a low level. The high level of the short-circuit detection signal Ssd is an example of a sixth value.

FIG. 5 is a schematic diagram of the short-circuit detection circuit 16 according to the first embodiment. The short-circuit detection circuit 16 according to the first embodiment includes a MOS transistor Q3, a resistor 161, and a logic inverter 162. The resistor 161 may be a constant current source. The MOS transistor Q3 is, for example, a P-type MOS transistor. The positive power supply voltage VDD is applied to the source of the MOS transistor Q3. The external negative voltage VM is applied to the gate of the MOS transistor Q3. The drain of the MOS transistor Q3 is connected to ground via the resistor 161. The connection point between the drain of the MOS transistor Q3 and the resistor 161 is connected to the inverter 162. The inverter 162 inverts the voltage applied from the connection point to generate the short-circuit detection signal Ssd having a high level or a low level. The short-circuit detection circuit 16 generates the short-circuit detection signal Ssd having a high level when the potential difference between the positive power supply voltage VDD and the external negative voltage VM becomes smaller than the threshold voltage of the MOS transistor Q3.

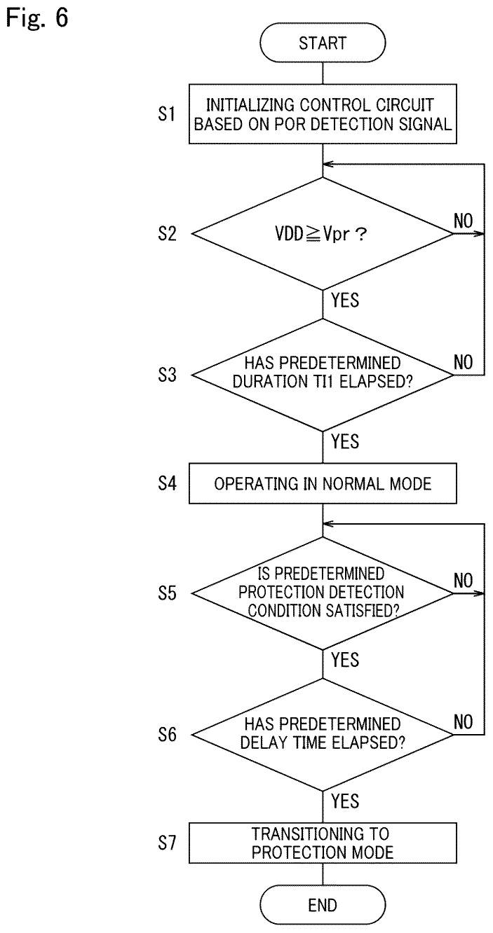

The operation of the charge and discharge control circuit 1 according to the first embodiment will be described. FIG. 6 is a flowchart illustrating an example of the operation of the charge and discharge control circuit 1 according to the first embodiment.

The charge and discharge control circuit 1 switches the control circuit 14 to the initialization mode based on the POR detection signal Spord and initializes each state of the control circuit 14 (S1). Specifically, the control circuit 14 detects the occurrence of the POR detection signal Spord having a high level via the POR state signal Spors and transitions to the initialization mode. After initializing each state, the control circuit 14 controls, for example, the levels of each signal to a predetermined initial state. For example, the control circuit 14 controls the discharge control signal DO and the charge control signal CO to hold the discharge control transistor 3 and the charge control transistor 4 in the predetermined initial state. In the charge and discharge control circuit 1 according to the first embodiment, the control circuit 14 controls the discharge control signal DO and the charge control signal CO to hold the discharge control transistor 3 and the charge control transistor 4 in the conductive state that is their initial states.

Next, the charge and discharge control circuit 1 determines whether the positive power supply voltage VDD is greater than or equal to the POR release voltage Vpr by the POR detection circuit 10 (S2). When VDD is not greater than or equal to Vpr (S2: NO), the charge and discharge control circuit 1 executes step S2 again. When VDD is greater than or equal to Vpr (S2: YES), the counter circuit 12 starts measuring time after VDD becomes greater than or equal to Vpr, and the charge and discharge control circuit 1 determines, by the counter circuit 12, whether the predetermined duration TI1 has elapsed since the occurrence of the POR duration measurement request Sporc having a high level (S3). When the predetermined duration TI1 has not elapsed (S3: NO), the charge and discharge control circuit 1 executes step S2 again. When the predetermined duration TI1 has elapsed (S3: YES), the charge and discharge control circuit 1 switches the control circuit 14 from the initialization mode to the normal mode and operates in the normal mode (S4).

The charge and discharge control circuit 1 then determines, by the control circuit 14, whether a predetermined protection detection condition is satisfied (S5). For example, the control circuit 14 may determine that the protection detection condition is satisfied when the control circuit 14 receives the overdischarge detection signal Sod having a high level or the short-circuit detection signal Ssd having a high level. When the protection detection condition is not satisfied (S5: NO), the charge and discharge control circuit 1 executes step S5 again. When the protection detection condition is satisfied (S5: YES), the charge and discharge control circuit 1 determines, by the control circuit 14, whether a predetermined delay time based on the satisfied protection detection condition has elapsed after the protection detection condition is satisfied (S6). The predetermined delay time may be, for example, the delay time Td2 or the delay time Td3.

If the predetermined delay time has not elapsed (S6: NO), the charge and discharge control circuit 1 executes step S5 again. If the predetermined delay time has elapsed (S6: YES), the charge and discharge control circuit 1 switches the control circuit 14 from the normal mode to the protection mode based on the satisfied protection detection condition, and operates in the protection mode (S7). Thus, upon power-on of the positive power supply voltage VDD, the charge and discharge control circuit 1 operates in the initialization mode until the predetermined duration TI1 has elapsed, and then operates in the normal mode. Furthermore, if the charge and discharge control circuit 1 detects an abnormality while operating in the normal mode, the charge and discharge control circuit 1 operates in the predetermined protection mode after the predetermined delay time has elapsed, thereby preventing damage to the battery device 1000 or the load 2000 due to the abnormality.

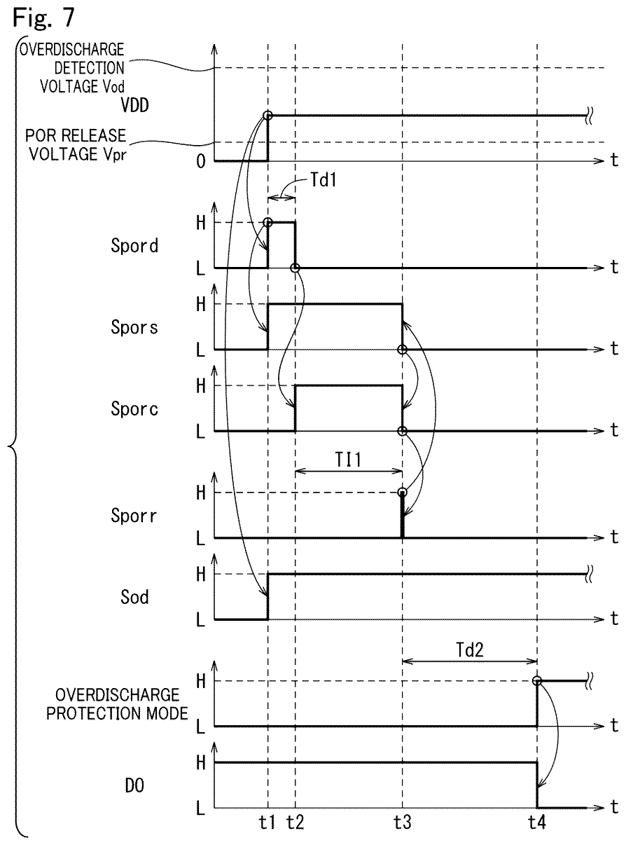

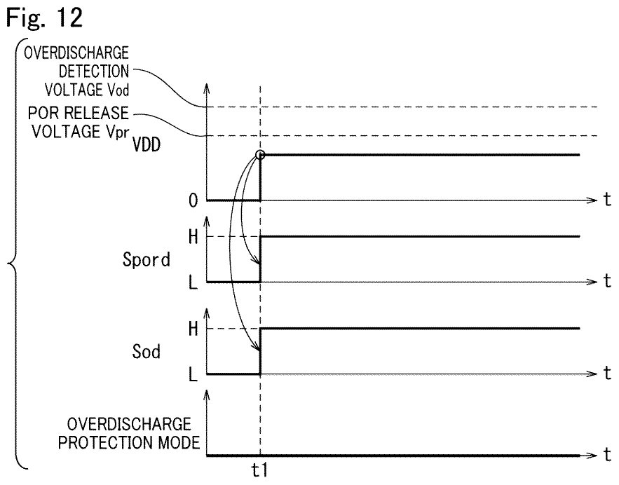

FIG. 7 is a timing chart illustrating an example of the operation of the charge and discharge control circuit 1 according to the first embodiment. The example shown in FIG. 7 shows a timing chart relating to the overdischarge protection mode. The horizontal axis of FIG. 7 represents time. The vertical axes of FIG. 7 represent the positive power supply voltage VDD, the level of the POR detection signal Spord, the level of the POR state signal Spors, the level of the POR duration measurement request Spore, the level of the POR release signal Sporr, the level of the overdischarge detection signal Sod, the state of the overdischarge protection mode and the level of the discharge control signal DO, respectively. In FIG. 7 and FIGS. 12, 15, and 17 described later, the waveforms of the overdischarge protection mode are shown at a high level when the overdischarge protection mode is on and at a low level when the overdischarge protection mode is off.

At time t1, for example, when the secondary battery 2 is connected to the positive power supply terminal T1 and the negative power supply terminal T2, the positive power supply voltage VDD rises to a predetermined voltage. When the positive power supply voltage VDD rises, the POR detection circuit 10 generates the POR detection signal Spord having a high level as the initial state. The POR detection circuit 10 may be configured to detect power-on of the positive power supply voltage VDD and generate the POR detection signal Spord having a high level upon detecting that the positive power supply voltage VDD has reached a predetermined voltage or greater. The predetermined voltage may be, for example, a voltage greater than 0 V and less than the POR release voltage Vpr. Upon receiving the high-level POR detection signal Spord, the SR latch 11 generates the POR state signal Spors having a high level. Upon receiving the high-level POR state signal Spors, the control circuit 14 operates in the initialization mode. Moreover, when the overdischarge detection circuit 15 detects that the positive power supply voltage VDD is less than the overdischarge detection voltage Vod, the overdischarge detection circuit 15 generates the overdischarge detection signal Sod having a high level.

When VDD becomes greater than or equal to Vpr at time t1, the POR detection circuit 10 generates the POR detection signal Spord having a high level from time t1 to time t2, which is the delay time Td1 after time t1. At time t2, because the POR detection signal Spord is at a low level and the POR state signal Spors is at a high level, the AND circuit 13 generates the POR duration measurement request Sporc having a high level. Upon receiving the POR duration measurement request Sporc having a high level, the counter circuit 12 measures the predefined POR duration TI1.

At time t3, which is the time after the POR duration TI1 has elapsed from time t2, the counter circuit 12 generates the POR release signal Sporr having a high level. Upon receiving the high-level POR release signal Sporr, the SR latch 11 generates the POR state signal Spors having a low level. Thus, even when the low POR detection signal Spord having a low level is generated after the POR detection signal Spord having a high level is generated, the SR latch 11 maintains the POR state signal Spors having a high level until the POR release signal Sporr having a high level is generated. In other words, the SR latch 11 maintains the high-level POR state signal Spors during the delay time Td1 and the POR duration TI1. When the POR state signal Spors having a low level is generated, the AND circuit 13 generates the POR duration measurement request Sporc having a low level, which causes the counter circuit 12 to generate the POR release signal Sporr having a low level.

Furthermore, upon receiving the POR state signal Spors having a low level, the control circuit 14 switches from the initialization mode to the normal mode. Thus, the control circuit 14 operates in the initialization mode during the delay time Td1 and the POR duration TI1. Because the overdischarge detection signal Sod has a high level at time t3, the control circuit 14 switches from the normal mode to the overdischarge protection mode at time t4, which is the delay time Td2 after time t3. Further, the control circuit 14 generates the discharge control signal DO having a low level to turn off the discharge control transistor 3. The delay time Td2 is an example of a third time interval.

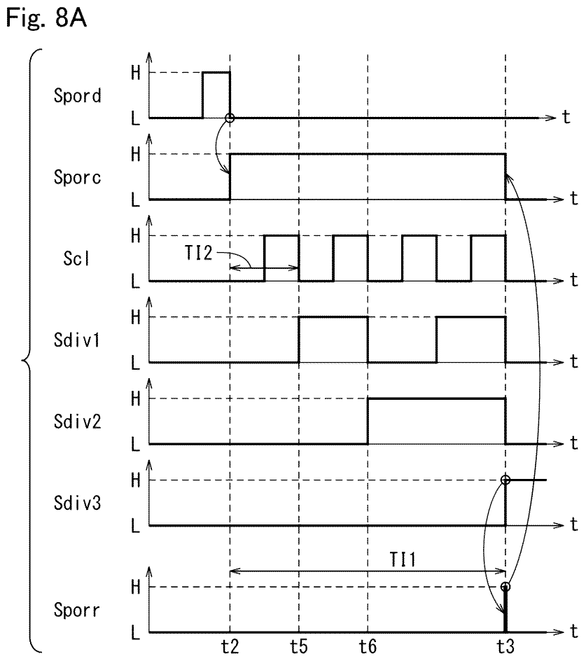

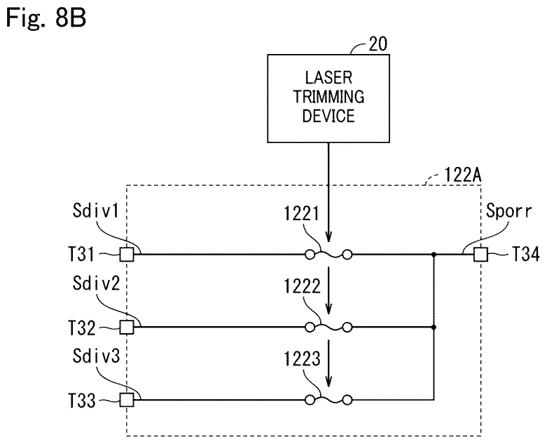

FIG. 8A is a timing chart illustrating an example of the operation of the counter circuit 12 according to the first embodiment. The horizontal axis of FIG. 8A represents time. The vertical axes of FIG. 8A represent the level of the POR detection signal Spord, the level of the POR duration measurement request Sporc, the level of the clock signal Scl, the levels of the frequency-divided signals Sdiv1 to Sdiv3, and the level of the POR release signal Sporr, respectively.

As described above, upon receiving the POR detection signal Spord having a low level at time t2, the AND circuit 13 generates the POR duration measurement request signal Sporc having a high level. As a result, the oscillator circuit 120 switches the clock signal Scl between a high level and a low level at predetermined periods TI2. At time t5, when the clock signal Scl changes to a low level after the first period has elapsed, the frequency divider circuit 121 generates the frequency-divided signal Sdiv1 having a high level. At time t6, when the clock signal Scl changes to a low level after the second period has elapsed, the frequency divider circuit 121 generates the frequency-divided signal Sdiv1 having a low level and the frequency-divided signal Sdiv2 having a high level. When the clock signal Scl changes to a low level after the third period has elapsed, the frequency divider circuit 121 generates the frequency-divided signal Sdiv1 having a high level.

When the clock signal Scl changes to a low level at time t3 after the fourth period has elapsed, the frequency divider circuit 121 generates the frequency-divided signals Sdiv1 and Sdiv2 having a low level and also generates the frequency-divided signal Sdiv3 having a high level. For example, if the predetermined period is 0.25 ms and the preset duration TI1 is 1 ms, upon receiving the frequency-divided signal Sdiv3 having a high level, the time setting circuit 122 generates the POR release signal Sporr having a high level. In this way, the counter circuit 12 measures the preset duration TI1 based on the change of the POR detection signal Spord to a low level and generates the POR release signal Sporr having a high level.

FIG. 8B is a schematic diagram illustrating an example of a time setting method for the time setting circuit 122 according to the first embodiment FIG. 8B shows a first setting circuit 122A, which is a part of the time setting circuit 122. The first setting circuit 122A is a circuit for timing the duration TI1 related to the POR release signal Sporr. The first setting circuit 122A includes terminals T31 to T34 and a plurality of fuses 1221 to 1223. The fuse 1221 has one end connected to the terminal T31 and the other end connected to the terminal T34. The fuse 1222 has one end connected to the terminal T32 and the other end connected to the terminal T34. The fuse 1223 has one end connected to the terminal T33 and the other end connected to the terminal T34.

The divided signal Sdiv1 is applied to terminal T31. The divided signal Sdiv2 is applied to the terminal T32. The divided signal Sdiv3 is applied to the terminal T33. The terminal T34 generates the POR release signal Sporr having a predetermined level.

In the first setting circuit 122A, two of the three fuses 1221 to 1223 are blown by the laser trimming device 20. The first setting circuit 122A generates the POR release signal Sporr from the frequency-divided signal Sdiv applied to the remaining fuse. For example, when fuses 1222 and 1223 are blown, the duration TI1 is set to the time interval from the application of the POR duration measurement request Sporc having a high level to the generation of the frequency-divided signal Sdiv1 having a high level, i.e., 0.25 ms. The first setting circuit 122A generates the POR release signal Sporr having a high level 0.25 ms after the high-level POR duration measurement request Sporc is applied. For example, when fuses 1221 and 1223 are blown, the duration TI1 is set to 0.5 ms. For example, when fuses 1221 and 1222 are blown, the duration TI1 is set to 1 ms. In this way, the time setting circuit 122 can generate the POR release signal Sporr having a high level after a predetermined time interval from the application of the POR duration measurement request Sporc.

If the time setting circuit 122 is to time a different time interval for each input signal, it may include another setting circuit having a configuration similar to that of the first setting circuit 122A. The other setting circuit may include, for example, an AND circuit that generates a signal having the level of the logical AND of two or more frequency-divided signals Sdiv and outputs the signal to a fuse. The other setting circuit may be configured to time another predetermined time interval based on a plurality of the frequency-divided signals Sdiv using a plurality of fuses and one or more AND circuits. In this way, the time setting circuit 122 includes a plurality of circuits that time predetermined time intervals based on a plurality of the frequency-divided signals Sdiv, and each circuit can be used to time each of a plurality of the predetermined time intervals.

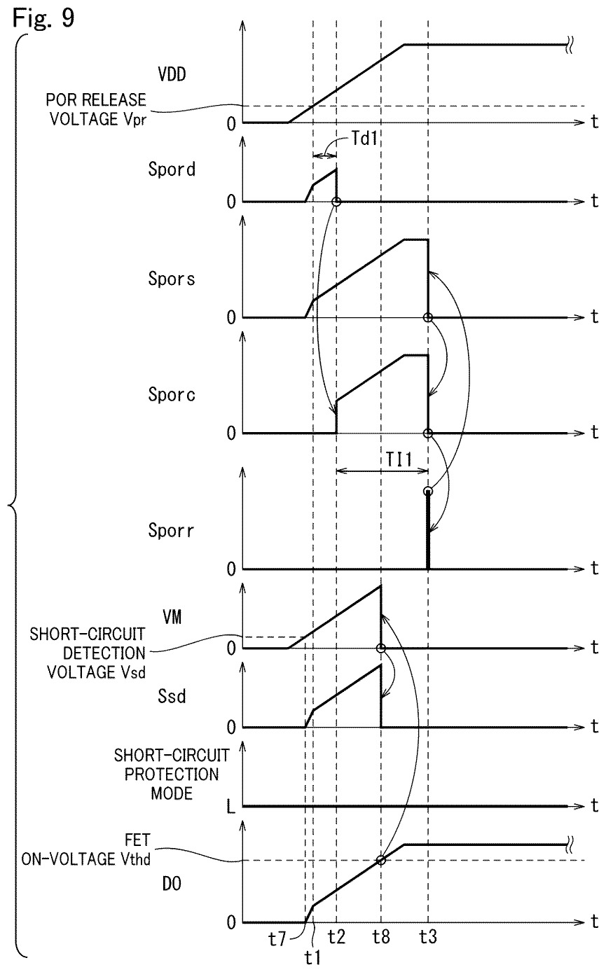

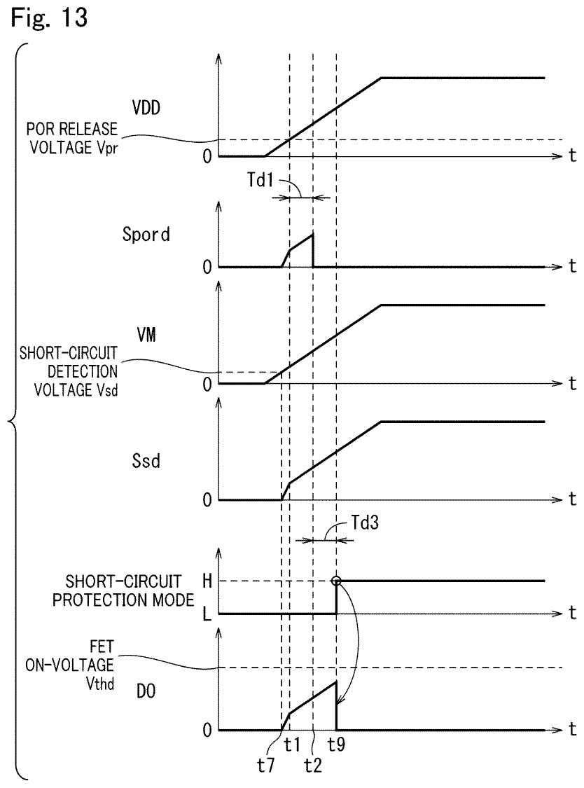

FIG. 9 is a timing chart illustrating another example of the operation of the charge and discharge control circuit 1 according to the first embodiment. The example shown in FIG. 9 is a timing chart relating to the short-circuit protection mode. The timing chart shown in FIG. 9 illustrates an example in which the positive power supply voltage VDD rises more slowly than the example shown in FIG. 7. For example, when the secondary battery 2 is connected to the charge and discharge control circuit 1, and the discharge current from the secondary battery 2 is small and the capacity of the load 2000 is large, it may take a certain time to charge the load capacity. In this case, the positive power supply voltage VDD rises slowly and may take a certain time to reach the positive voltage of the secondary battery 2. Furthermore, for example, when a power supply device is connected instead of the secondary battery 2 for testing or evaluation of the charge and discharge control circuit 1, the positive power supply voltage VDD may rise slowly, depending on the rising speed of the signal from the power supply device. The horizontal axis of FIG. 9 represents time. The vertical axes in FIG. 9 represent the positive power supply voltage VDD, the level of the POR detection signal Spord, the level of the POR state signal Spors, the level of the POR duration measurement request Sporc, the level of the POR release signal Sporr, the external negative voltage VM, the level of the short-circuit detection signal Ssd, the state of the short-circuit protection mode, and the level of the discharge control signal DO, respectively. Specifically, in FIG. 9 and FIG. 13 described later, the waveform of each signal represents a voltage output from a circuit to indicate the level of the signal. For example, each signal indicates a high level when its voltage is greater than 0. In FIG. 9 and FIG. 13 described later, the waveforms of the short-circuit protection mode are shown at a high level when the short-circuit protection mode is on and at a low level when the short-circuit protection mode is off.

In FIGS. 9 and 13, when the voltage of each signal is controlled to have a high level, the voltage increases in response to an increase in the positive power supply voltage VDD. As will be described later, when the positive power supply voltage VDD increases, the external negative voltage VM also increases.

When the positive power supply voltage VDD rises, the POR detection signal Spord changes to a high level, causing the voltages of the POR detection signal Spord and the POR state signal Spors to rise. When the control circuit 14 detects the rise in the voltage of the POR state signal Spors, i.e., when the control circuit 14 receives the POR state signal Spors having a high level, the control circuit 14 operates in the initialization mode. When the positive power supply voltage VDD rises to the POR release voltage Vpr at time t1, the POR detection circuit 10 generates the POR detection signal Spord having a low level at time t2, which is the predetermined delay time Td1 after time t1. Because the POR detection signal Spord has a low level and the POR state signal Spors has a high level at time t2, the AND circuit 13 generates the POR duration measurement request Sporc having a high level.

Upon receiving the POR duration measurement request Sporc having a high level, the counter circuit 12 measures the predetermined POR duration TI1. At time t3, which is the POR duration TI1 after time t2, the counter circuit 12 generates the POR release signal Sporr having a high level. This causes the SR latch 11 to generate the POR state signal Spors having a low level, and the control circuit 14 switches from the initialization mode to the normal mode. Furthermore, the AND circuit 13 generates the POR duration measurement request Spore having a low level. The counter circuit 12 then generates the POR release signal Sporr having a low level.

As described above, in the first embodiment, the control circuit 14 controls the discharge control signal DO to maintain the discharge control transistor 3 in the conductive state during operation in the initialization mode. Therefore, the control circuit 14 maintains the discharge control signal DO at a high level. The discharge control signal DO is applied to the gate of the discharge control transistor 3 based on the positive power supply voltage VDD. In the example shown in FIG. 9, because the positive power supply voltage VDD rises slowly, the time interval during which the discharge control signal DO is controlled to have a high level includes a time interval during which the voltage of the discharge control signal DO is less than a predetermined FET on-voltage Vthd. In the timing chart shown in FIG. 9, for example, the time interval from time t7 to time t8 indicates the time interval during which DO is less than Vthd. The FET on-voltage Vthd indicates the gate voltage of the discharge control transistor 3 required to turn on the discharge control transistor 3.

During the time interval when DO is less than Vthd, the discharge control transistor 3 is in the open state. Therefore, the discharge current flowing from the secondary battery 2 to the load 2000 via the discharge control transistor 3 is cut off. While the discharge control transistor 3 is in the open state, the external negative voltage VM is pulled up to the same potential as the external positive voltage by the load 2000, and therefore rises along with the positive power supply voltage VDD. At time t7, when VM becomes greater than or equal to Vsd, the short-circuit detection circuit 16 generates the short-circuit detection signal Ssd having a high level even though no short-circuit has occurred. As described above, the control circuit 14 operates in the initialization mode until time t3 after power-on of the positive power supply voltage VDD. Therefore, even if the control circuit 14 receives the high-level short-circuit detection signal Ssd, the control circuit 14 does not transition to the short-circuit protection mode while operating in the initialization mode.

At time t8, when the discharge control signal DO rises to a voltage greater than or equal to the FET on-voltage Vthd, the discharge control transistor 3 switches from the open state to the conductive state. When the discharge control transistor 3 turns on, the external negative voltage VM becomes equal to the negative power supply voltage VSS, causing the short-circuit detection circuit 16 to generate the short-circuit detection signal Ssd having a low level.

As described above, according to the charge and discharge control circuit 1 of the first embodiment, even if the POR release voltage Vpr is set to a low value, it is possible to prevent an unintended transition to the short-circuit protection mode upon power-on of the positive power supply voltage VDD. Furthermore, according to the charge and discharge control circuit 1 of the first embodiment, it is possible to set the POR release voltage Vpr to a value that allows a transition to the overdischarge protection mode if an overdischarge occurs upon power-on of the positive power supply voltage VDD. For example, the POR release voltage Vpr can be set to a voltage that is greater than 0 V and less than an undervoltage lockout voltage as will be described below.

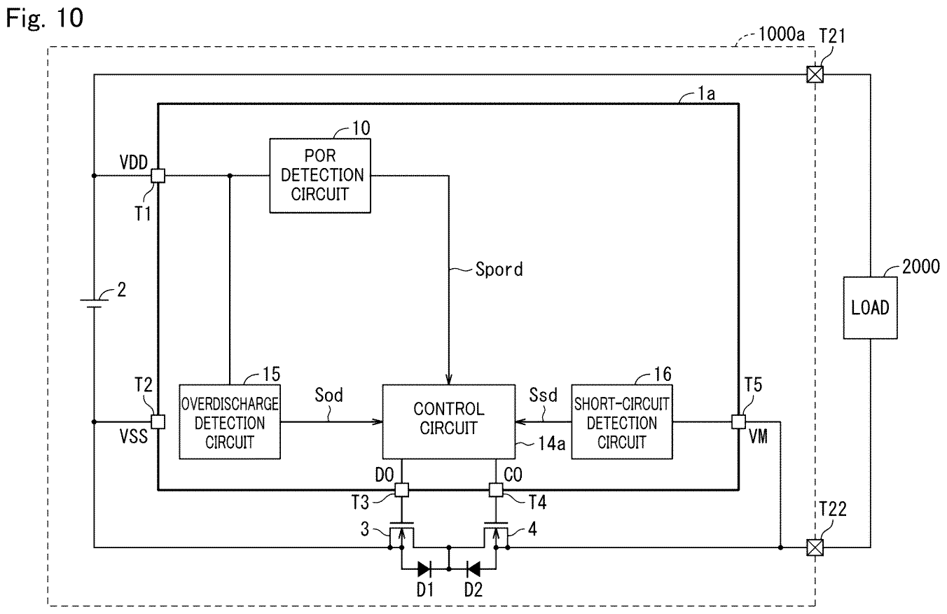

FIG. 10 is a schematic diagram of a battery device 1000a according to a comparative example. The battery device 1000a includes a charge and discharge control circuit 1a instead of the charge and discharge control circuit 1 in the first embodiment. The charge and discharge control circuit 1a does not include the SR latch 11, the counter circuit 12, or the AND circuit 13, and includes a control circuit 14a instead of the control circuit 14 in the first embodiment.

The POR detection circuit 10 generates the POR detection signal Spord based on the positive power supply voltage VDD and outputs the POR detection signal Spord to the control circuit 14a. The control circuit 14a operates in the initialization mode based on the POR detection signal Spord having a high level. The control circuit 14a operates in the normal mode based on the POR detection signal Spord having a low level.

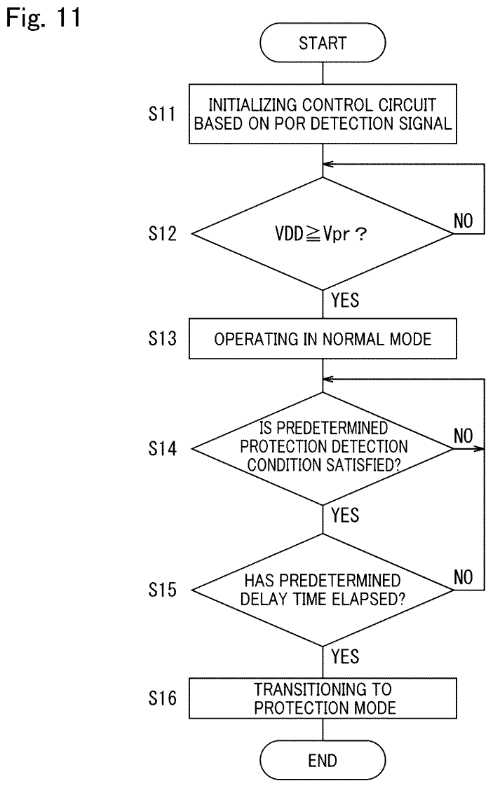

FIG. 11 is a flowchart illustrating an example of the operation of the charge and discharge control circuit 1a according to the comparative example.

Based on the POR detection signal Spord, the charge and discharge control circuit 1a switches the control circuit 14a to the initialization mode and initializes each state of the control circuit 14a (S11). The charge and discharge control circuit 1a executes step S12, similar to step S2 in FIG. 6. When VDD is greater than or equal to Vpr (S12: YES), the charge and discharge control circuit 1a switches the control circuit 14a from the initialization mode to the normal mode and operates in the normal mode (S13). Thereafter, the charge and discharge control circuit 1a executes steps S14 to S16, similar to steps S5 to S7 in FIG. 6.

FIG. 12 is a timing chart illustrating an example of the operation of the charge and discharge control circuit 1a according to the comparative example. The example shown in FIG. 12 shows a timing chart relating to the overdischarge protection mode. The horizontal axis of FIG. 12 represents time. The vertical axes of FIG. 12 represent the positive power supply voltage VDD, the level of the POR detection signal Spord, the level of the overdischarge detection signal Sod, and the state of the overdischarge protection mode, respectively.

At time t1, upon power-on of the positive power supply voltage VDD, the POR detection circuit 10 generates the POR detection signal Spord having a high level. When the control circuit 14a receives the high-level POR detection signal Spord, the control circuit 14a operates in the initialization mode. When the overdischarge detection circuit 15 detects that the positive power supply voltage VDD is less than the overdischarge detection voltage Vod, the overdischarge detection circuit 15 generates the overdischarge detection signal Sod having a high level.

After time t1, the positive power supply voltage VDD is less than the overdischarge detection voltage Vod and less than the POR release voltage Vpr. Therefore, the control circuit 14a continues to operate in the initialization mode. In this case, the control circuit 14a does not transition to the overdischarge protection mode even though the overdischarge detection signal Sod has a high level. If the POR release voltage Vpr is set to a value greater than the expected positive power supply voltage VDD, the control circuit 14a will not transition to the overdischarge protection mode even though overdischarge is occurring, and the power supply voltage of the secondary battery 2 may further decrease. As such, the charge and discharge control circuit 1a according to the comparative example may not be able to protect the secondary battery 2 from overdischarge. In order for the charge and discharge control circuit 1a to reliably protect the secondary battery 2 from overdischarge, the POR release voltage Vpr is required to be set to a value less than the expected positive power supply voltage VDD.

For example, the POR release voltage Vpr can be set to a value less than an undervoltage lockout (UVLO) voltage. In this specification, the undervoltage lockout voltage refers to a threshold value at which the control circuits 14, 14a transition to an undervoltage lockout mode. The control circuits 14, 14a transition to the undervoltage lockout mode when they detect that the positive power supply voltage VDD is less than the undervoltage lockout voltage. If the voltage of the secondary battery is less than the undervoltage lockout voltage, the secondary battery rapidly deteriorates. Therefore, the control circuits 14, 14a prohibit recharging of the secondary battery 2 upon transition to undervoltage lockout mode. If the POR release voltage Vpr is set to a voltage greater than the undervoltage lockout voltage, the control circuit 14a may not transition to overdischarge protection mode even if the secondary battery 2 with a low power supply voltage is connected to the charge and discharge control circuit 1a. If overdischarge protection is not performed, the power supply voltage VDD of the secondary battery 2 will further decrease due to discharge, resulting in a transition to undervoltage lockout mode.

If the POR release voltage Vpr is set to a value less than the undervoltage lockout voltage, the control circuit 14a can prevent the transition to the undervoltage lockout mode. For example, the undervoltage lockout voltage may be generally set to about 1 V. If the POR release voltage Vpr is set to 0.8 V or the like, and the positive power supply voltage VDD has a low value, the control circuit 14a transitions to the overdischarge protection mode upon power-on of the positive power supply voltage VDD. Therefore, the control circuit 14a can prevent the transition to the undervoltage lockout mode due to discharge after power-on of the positive power supply voltage VDD. However, if the POR release voltage Vpr is set to such a voltage, the short-circuit protection problem described with reference to FIG. 13 may occur.

FIG. 13 is a timing chart illustrating another example of the operation of the charge and discharge control circuit 1a according to the comparative example. The example shown in FIG. 13 shows a timing chart relating to the short-circuit protection mode. The horizontal axis of FIG. 13 represents time. The vertical axes of FIG. 13 represent the positive power supply voltage VDD, the level of the POR detection signal Spord, the external negative voltage VM, the level of the short-circuit detection signal Ssd, the state of the short-circuit protection mode, and the level of the discharge control signal DO, respectively.

When the positive power supply voltage VDD rises, the voltage of the POR detection signal Spord also rises. When the control circuit 14a detects a rise in the voltage of the POR detection signal Spord, i.e., when the control circuit 14a receives the POR detection signal Spord having a high level, the control circuit 14a operates in the initialization mode. When the positive power supply voltage VDD rises to the POR release voltage Vpr at time t1, the POR detection circuit 10 generates the POR detection signal Spord having a low level at time t2, which is the predetermined delay time Td1 after time t1. When the control circuit 14a receives the POR detection signal Spord having a low level, the control circuit 14a transitions from the initialization mode to the normal mode.

During operation in the initialization mode, the control circuit 14a maintains the discharge control signal DO at a high level. While DO is less than Vthd, the discharge control transistor 3 is in the open state. Therefore, the external negative voltage VM rises in line with the positive power supply voltage VDD. At time t7, when VM becomes greater than or equal to Vsd, the short-circuit detection circuit 16 generates the short-circuit detection signal Ssd having a high level even though no short-circuit has occurred. As described above, the control circuit 14a transitions to the normal mode at time t2. Therefore, when the control circuit 14a receives the high-level short-circuit detection signal Ssd at time t2, the control circuit 14a transitions from the normal mode to the short-circuit protection mode at time t9, which is the predetermined delay time Td3 after time t2.

When the control circuit 14a transitions to the short-circuit protection mode, the control circuit 14a generates the discharge control signal DO having a low level to turn off the discharge control transistor 3. Since the external negative voltage VM is pulled up to the same potential as the external positive voltage even after time t9, the external negative voltage VM rises along with the positive electrode power supply voltage VDD. Since VM is maintained to be greater than or equal to Vsd, the short-circuit detection circuit 16 maintains the short-circuit detection signal Ssd at a high level. In this case, the control circuit 14a continues to operate in the short-circuit protection mode, so that the battery device 1000a does not discharge to the load 2000.

As in the example of FIG. 12, even if the positive power supply voltage VDD rises quickly, a certain time may be required for the discharge control switch 3 and the charge control switch 4 to tum on. For example, depending on the relationship between the discharge current from the secondary battery 2 and the gate capacitance of the discharge control switch 3 and the charge control switch 4, it may take a certain time for charge to accumulate in the gate, and the discharge control switch 3 and the charge control switch 4 may not be turned on simultaneously with the rise. If the discharge control switch 3 and the charge control switch 4 are in the open state, the external negative voltage VM is pulled up to the same potential as the external positive voltage by the load 2000, which may cause the short-circuit detection circuit 16 to erroneously detect a short-circuit. In such a case, the control circuit 14a transitions from, for example, the normal mode to the short-circuit protection mode and continues to operate in the short-circuit protection mode, as described above, and the battery device 1000a does not discharge to the load 2000.

Thus, in order to protect the secondary battery 2 from overdischarge when the secondary battery 2 is overdischarged, the charge and discharge control circuit 1a according to the comparative example is required to set the POR release voltage Vpr as low as possible, such as a value less than the low-voltage lock mode voltage. However, if the POR release voltage Vpr is set to the low value, the charge and discharge control circuit 1a according to the comparative example may transition to short-circuit protection mode under unintended circumstances. To prevent such malfunction, it is necessary to lengthen the delay time Td1 in the POR detection circuit 10. However, adjusting the output width of the single-pulse signal makes it difficult to flexibly adjust the delay time Td1. Furthermore, to lengthen the output width of the single-pulse signal, it is necessary to increase, for example, the resistance of the resistor 101 and the capacitance of the capacitor 102 in FIG. 2 included in the POR detection circuit 10.

According to the charge and discharge control circuit 1 of the first embodiment, the control circuit 14 maintains the initialization mode until the predetermined duration TI1 has elapsed after the positive power supply voltage VDD exceeds the POR release voltage Vpr. Thus, the discharge control transistor 3 and the charge control transistor 4 are maintained in a predetermined initial state. Therefore, the charge and discharge control circuit 1 can prevent malfunction of the charge and discharge control circuit 1 regardless of the conditions at power-on of the power supply voltage. Thus, the charge and discharge control circuit 1 can suppress malfunction of the protection function for the secondary battery 2, even when the positive power supply voltage VDD rises slowly, when it takes a certain time to turn on the charge control switch 4 or the discharge control switch 3, or when a short-circuit is falsely detected due to an inrush current charging the load capacitance immediately after the positive power supply voltage VDD rises, while setting the POR release voltage Vpr to a low voltage less than the undervoltage lockout voltage. Therefore, the charge and discharge control circuit 1 can more appropriately protect the secondary battery 2 from abnormalities related to charging and discharging upon power-on of the positive power supply voltage VDD.

In the above embodiment, the POR detection circuit 10 generates the POR detection signal having a high level when the POR detection circuit 10 detects power-on of the positive power supply voltage VDD. However, the operation of the charge and discharge control circuit 1 is not limited to this process. The POR detection circuit 10 may be configured to generate the POR detection signal having a low level when it detects power-on of the positive power supply voltage VDD. For example, the low level of the POR detection signal Spord may be the first value, and the high level may be the second value. Similarly, the low level of the POR state signal Spors may be the third value, and the high level may be the fourth value. Furthermore, the low level of the POR release signal Sporr may be the fifth value, and the low level of the abnormality detection signal such as the overdischarge detection signal Sod or the short-circuit detection signal Ssd may be the sixth value. In this way, the charge and discharge control circuit 1 may be configured to operate using signals with levels different from those of the signals in the first embodiment.

The charge and discharge control circuit 1 according to the first embodiment of the present disclosure can achieve the following effects.

The charge and discharge control circuit 1 for preventing malfunction at power-on of an input power supply voltage VDD includes a first detection circuit 10, a counter circuit 12, and a control circuit 14. The first detection circuit 10 generates a POR detection signal Spord based on the power supply voltage VDD. The first detection circuit 10 generates the POR detection signal Spord having a first value for a first time interval Td1 based on detection of power-on of the power supply voltage VDD, and generates the POR detection signal Spord having a second value after the first time interval Td1 has elapsed. The counter circuit 12 is initialized based on the POR detection signal having the first value, and measures the second time interval TI1 based on the POR detection signal Spord having the second value. The control circuit 14 is configured to hold a first switch 3 for controlling discharging of the secondary battery 2 that outputs the power supply voltage VDD and a second switch 4 for controlling charging of the secondary battery 2, in respective predetermined initial states during the first time interval Td1 and the second time interval TI1.

With this configuration, after detecting power-on of the power supply voltage VDD, the control circuit 14 holds the first switch 3 and the second switch 4 in their respective predetermined initial states until the second time interval TI1 has elapsed. Therefore, the charge and discharge control circuit 1 can prevent malfunction of the protection function of the charge and discharge control circuit 1 for the secondary battery 2, irrespective of voltage changes upon power-on of the power supply voltage VDD (e.g., the time required for power-on of the power supply voltage). Furthermore, the charge and discharge control circuit 1 can count the second time interval TI1 using the counter circuit 12 based on the POR detection signal Spord and the POR state signal Spors, which have predetermined levels, without using the control circuit 14. Therefore, the second time interval TI1 can be changed by adjusting the counter circuit 12, and the charge and discharge control circuit 1 can easily set an appropriate second time interval TI1 for each battery device 1000.

The charge and discharge control circuit 1 further includes a state holding circuit 11 that generates a POR state signal Spors based on the POR detection signal Spord. The state holding circuit 11 generates the POR state signal Spors having a third value based on the POR detection signal Spord having the first value, and holds the POR state signal Spors at the third value during the first time interval Td1 and the second time interval TI1. The state holding circuit 11 generates the POR state signal Spors having a fourth value after the second time interval TI1 has elapsed. The control circuit 14 releases each of the first switch 3 and the second switch 4 from being held in the predetermined initial states based on the POR state signal Spors having the fourth value.

With this configuration, the charge and discharge control circuit 1 can hold the POR state signal Spors at the third value using the state holding circuit 11 until the second time interval TI1 has elapsed after detecting power-on of the power supply voltage VDD. The control circuit 14 holds the first switch 3 and the second switch 4 in their respective predetermined initial states while the POR state signal Spors is held at the third value. Therefore, the charge and discharge control circuit 1 can prevent malfunction of its protection function for the secondary battery 2, irrespective of voltage changes upon power-on of the power supply voltage VDD.

The state holding circuit 11 latches the POR state signal Spors to the third value based on the POR detection signal Spord having the first value, and releases the latch after the second time interval TI1 has elapsed. With this configuration, the state holding circuit 11 can hold the POR state signal Spors at the third value until the second time interval TI1 has elapsed after power-on of the power supply voltage VDD. The control circuit 14 holds the first switch 3 and the second switch 4 in their respective predetermined initial states while the POR state signal Spors is held at the third value. Therefore, the charge and discharge control circuit 1 can prevent malfunction of its protection function for the secondary battery 2, irrespective of voltage changes upon power-on of the power supply voltage VDD.

After the second time interval TI1 has elapsed, the counter circuit 12 generates a POR release signal Sporr having a fifth value and outputs the generated POR release signal Sporr to the state holding circuit 11. With this configuration, the state holding circuit 11 can detect that the second time interval TI1 has elapsed. The state holding circuit 11 can change the POR state signal Spors, which has been held at the third value, to the fourth value, and the control circuit 14 can release the first switch 3 and the second switch 4 from the their initial states. Therefore, the charge and discharge control circuit 1 can operate to protect the secondary battery 2 when an abnormality occurs after the power supply voltage VDD has stabilized, while preventing malfunction of the protection function of the charge and discharge control circuit 1 for the secondary battery 2, irrespective of voltage changes upon power-on of the power supply voltage VDD.

After releasing the first switch 3 and the second switch 4 from being held in respective predetermined initial states, the control circuit 14 detects an abnormality in charging or discharging of the secondary battery 2, and after the third time interval Td2 has elapsed, turns off the first switch 3 or the second switch 4. With this configuration, the charge and discharge control circuit 1 can operate to protect the secondary battery 2 when an abnormality occurs after the power supply voltage VDD has stabilized, while preventing malfunction of the protection function of the charge and discharge control circuit 1 for the secondary battery 2, irrespective of voltage changes upon power-on of the power supply voltage VDD.

The first detection circuit 10 generates the POR detection signal Spord having the first value based on the rise of the power supply voltage VDD, and generates the POR detection signal having the second value after the first time interval Td1 from the detection of power-on of the power supply voltage VDD. With this configuration, the first detection circuit 10 can generate the POR detection signal Spord having the first value after the rise of the power supply voltage VDD and until the first time interval Td1 has elapsed from the detection of the rise of the power supply voltage VDD. Therefore, the charge and discharge control circuit 1 can prevent malfunction of the protection function of the charge and discharge control circuit 1 for the secondary battery 2, irrespective of voltage changes upon power-on of the power supply voltage VDD.

The battery device 1000 includes the above-described charge and discharge control circuit 1, the secondary battery 2, the first switch 3 that controls discharging of the secondary battery 2, and the second switch 4 that controls charging of the secondary battery 2. With this configuration, the battery device 1000 can prevent malfunction of the protection function of the charge and discharge control circuit 1 for the secondary battery 2, irrespective of voltage changes upon power-on of the power supply voltage VDD.

A charge and discharge control method for preventing malfunction at power-on of an input power supply voltage VDD includes the following processing. The charge and discharge control method includes generating, by a detection circuit 10 that generates a POR detection signal Spord based on the power supply voltage VDD, generating the POR detection signal Spord having a first value for the first time interval Td1 based on detection of power-on of the power supply voltage VDD, and generating the POR detection signal Spord having a second value after the predetermined first time interval Td1 has elapsed. The charge and discharge control method further includes, by a counter circuit 12, measuring the predetermined second time interval TI1 based on the POR detection signal Spord having the second value. The counter circuit 12 is initialized based on the POR detection signal Spord having the first value. The charge and discharge control method further includes, by the control circuit 14, holding the first switch 3 for controlling discharging of a secondary battery 2 that outputs the power supply voltage VDD and the second switch 4 for controlling charging of the secondary battery 2, in respective predetermined initial states during the first time interval Td1 and the second time interval TI1.

By operating in this manner, in the charge and discharge control method, after detecting power-on of the power supply voltage VDD, the control circuit 14 holds the first switch 3 and the second switch 4 in their respective predetermined initial states until the second time interval TI1 has elapsed. Therefore, the charge and discharge control method can prevent malfunction of the protection function of the charge and discharge control circuit 1 for the secondary battery 2, irrespective of voltage changes upon power-on of the power supply voltage VDD.

### Second Embodiment

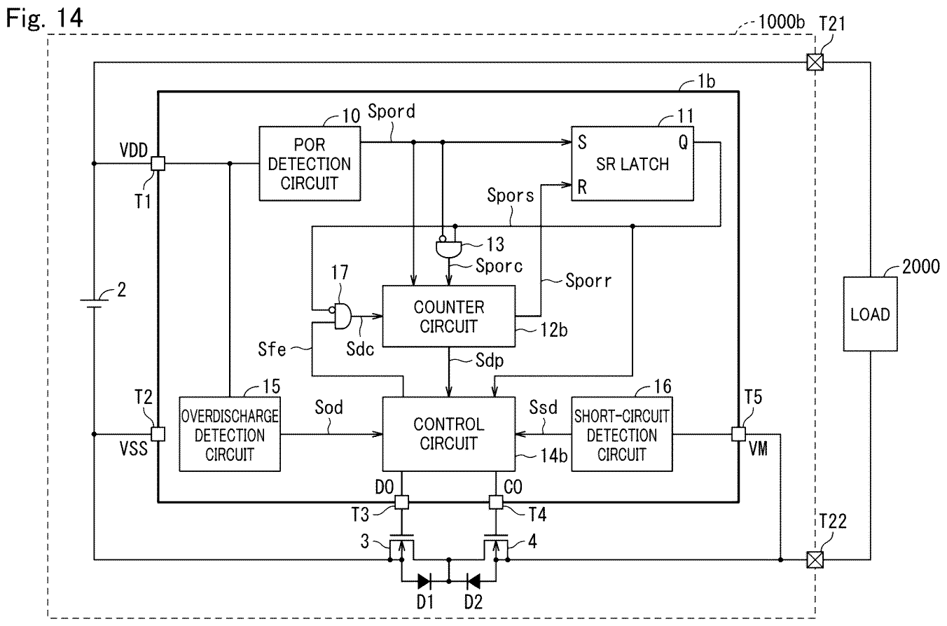

A battery device 1000b according to a second embodiment of the present disclosure will be described with reference to FIG. 14. FIG. 14 is a schematic diagram of the battery device 1000b according to the second embodiment of the present disclosure, The battery device 1000b includes a charge and discharge control circuit 1b instead of the charge and discharge control circuit 1 in the first embodiment. The charge and discharge control circuit 1b includes a counter circuit 12b, a control circuit 14b, and an AND circuit 17 instead of the counter circuit 12 and the control circuit 14.

The control circuit 14b generates an abnormality estimation signal Sfe based on the abnormality detection signal from the abnormality detection circuit such as the overdischarge detection circuit 15 or the short-circuit detection circuit 16, and outputs the signal Sfe to the AND circuit 17. The control circuit 14b generates the abnormality estimation signal Sfe having a high level based on the abnormality detection signal such as the overdischarge detection signal Sod or the short-circuit detection signal Ssd having a high level.

The counter circuit 12b generates a predetermined delay time elapse signal Sdp and outputs the signal Sdp to the control circuit 14b. The counter circuit 12b measures the abnormality detection delay time based on the abnormality estimation signal Sfe having a high level. The abnormality detection delay time is an example of the third time interval. Specifically, when the SR latch 11 generates the POR state signal Spors having a low level and the control circuit 14b generates the abnormality estimation signal Sfe having a high level, the counter circuit 12b starts counting and measures the abnormality detection delay time. After the abnormality detection delay time has elapsed, the counter circuit 12b generates the delay time elapse signal Sdp having a high level. The abnormality detection delay time can be easily changed using circuit switching method such as laser trimming.

In the second embodiment, the counter circuit 12b measures the abnormality detection delay time based on a delay time measurement request Sdc having a high level from the AND circuit 17. The counter circuit 12b may be configured to measure the abnormality detection delay time based on the POR state signal Spors having a low level and the abnormality estimation signal Sfe having a high level.

The AND circuit 17 generates the delay time measurement request Sdc having the level of the logical AND of the inverted value of the POR state signal Spors and the abnormality estimation signal Sfe, and outputs the request Sdc to the counter circuit 12b. Specifically, when the POR state signal Spors having a low level and the abnormality estimation signal Sfe having a high level are applied to the AND circuit 17, the AND circuit 17 generates the delay time measurement request Sdc having a high level, and in other cases generates the delay time measurement request Sdc having a low level.

The control circuit 14b transitions to the predetermined protection mode (the overdischarge protection mode, the short-circuit protection mode, etc.) based on the delay time elapsed signal Sdp having a high level and the detected abnormality.

For example, the control circuit 14b generates the abnormality estimation signal Sfe having a high level based on the overdischarge detection signal Sod having a high level from the overdischarge detection circuit 15. When the control circuit 14b generates the abnormality estimation signal Sfe having a high level and the SR latch 11 generates the POR state signal Spors having a low level, the counter circuit 12b measures a delay time Td4, which is the abnormality detection delay time related to overdischarge. After the delay time Td4 has elapsed, the counter circuit 12b generates the delay time elapse signal Sdp having a high level. Based on the delay time elapse signal Sdp having a high level, the control circuit 14b transitions to the overdischarge protection mode and turns off the discharge control transistor 3 by setting the discharge control signal DO to a low level.

For example, the control circuit 14b generates the abnormality estimation signal Sfe having a high level based on the short-circuit detection signal Ssd having a high level from the short-circuit detection circuit 16. When the control circuit 14b generates the abnormality estimation signal Sfe having a high level and the SR latch 11 generates the POR state signal Spors having a low level, the counter circuit 12b measures the abnormality detection delay time related to a short circuit. After the abnormality detection delay time has elapsed, the counter circuit 12b generates the delay time elapse signal Sdp having a high level. Based on the delay time elapse signal Sdp having a high level, the control circuit 14b transitions to the short-circuit protection mode and turns off the discharge control transistor 3 by setting the discharge control signal DO to a low level.

The control circuit 14b according to the second embodiment generates one abnormality estimation signal Sfe related to the abnormality detection based on the abnormality detection signal and receives one delay time elapse signal Sdp related to the abnormality detection, but is not limited to this configuration. For example, the control circuit 14b may be configured to generate a different abnormality estimation signal Sfe for each abnormality based on the abnormality detection signal indicating that a specific abnormality has been detected and output the signal to the counter circuit 12b. Alternatively, the counter circuit 12b may output the delay time elapse signal Sdp when the measurement time for each abnormality has elapsed since the start of counting, and the control circuit 14b may determine the elapse of the measurement time by calculating the logical product of the signal Sdp and the abnormality detection signal. Alternatively, the control circuit 14b may be configured to receive a different delay time elapse signal Sdp for each abnormality. Alternatively, the charge and discharge control circuit 1b may be configured to include a different AND circuit 17 for each abnormality.

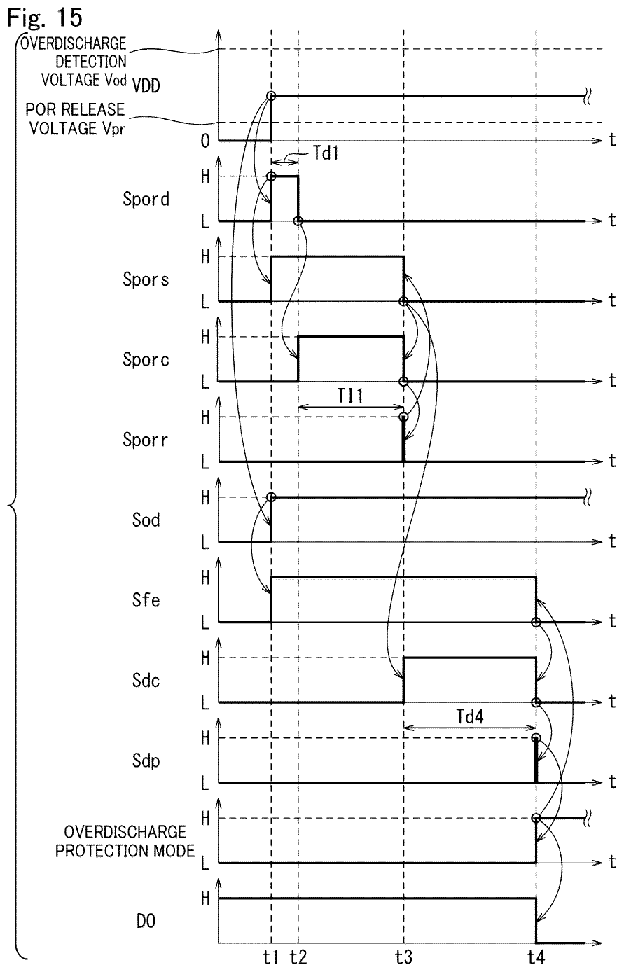

The operation of the charge and discharge control circuit 1b according to the second embodiment will be described. FIG. 15 is a timing chart illustrating an example of the operation of the charge and discharge control circuit 1b. The example shown in FIG. 15 shows a timing chart relating to the overdischarge protection mode. The horizontal axis of FIG. 15 represents time. The vertical axes of FIG. 15 represent the positive power supply voltage VDD, the level of the POR detection signal Spord, the level of the POR state signal Spors, the level of the POR duration measurement request Sporc, the level of the POR release signal Sport, the level of the overdischarge detection signal Sod, the level of the abnormality estimation signal Sfe, the level of the delay time measurement request Sdc, the level of the delay time elapse signal Sdp, the state of the overdischarge protection mode, and the level of the discharge control signal DO.

Between time t1 and time 13, the POR detection circuit 10, the SR latch 11, the counter circuit 12b, the AND circuit 13, and the overdischarge detection circuit 15 operate in the same manner as the circuits in the timing chart shown in FIG. 7.

At time t1, upon receiving the high-level overdischarge detection signal Sod. the control circuit 14b generates the abnormality estimation signal Sfe having a high level. At time t3, as described above, upon receiving the high-level POR release signal Sporr, the SR latch 11 generates the POR state signal Spors having a low level. Because the POR state signal Spors has a low level and the abnormality estimation signal Sfe has a high level, the AND circuit 17 generates the delay time measurement request Sdc having a high level. Upon receiving the high-level delay time measurement request Sdc, the counter circuit 12b measures the predetermined delay time Td4. The delay time Td4 is an example of the third time interval.

At time t4, after the delay time Td4 has elapsed since time t3, the counter circuit 12b generates the delay time elapse signal Sdp having a high level. Upon receiving the high-level delay time elapse signal Sdp, the control circuit 14b generates the abnormality estimation signal Sfe having a low level. Upon receiving the low-level abnormality estimation signal Sfe, the AND circuit 17 generates the delay time measurement request Sdc having a low level, which causes the counter circuit 12b to generate the delay time elapse signal Sdp having a low level.

When the control circuit 14b receives the POR state signal Spors having a low level at time t3, the control circuit 14b switches from the initialization mode to the normal mode. When the control circuit 14b receives the delay time elapse signal Sdp having a high level at time t4, the control circuit 14b switches from the normal mode to the overdischarge protection mode. The control circuit 14b generates the discharge control signal DO having a low level to turn off the discharge control transistor 3.

In this way, the charge and discharge control circuit 1b according to the second embodiment can operate to protect the secondary battery 2 when an abnormality occurs after the positive power supply voltage VDD has stabilized, while preventing malfunction of the protective function of the charge and discharge control circuit 1b for the secondary battery 2, irrespective of voltage changes at power-on of the positive power supply voltage VDD. Furthermore, the charge and discharge control circuit 1b can count the POR duration TI1 and the delay time Td4 by the counter circuit 12b. Therefore, the charge and discharge control circuit 1b can be configured to measure a plurality of time intervals by using one counter circuit 12b for different purposes.

The charge and discharge control circuit 1b according to the second embodiment of the present disclosure can achieve the following effects.

The charge and discharge control circuit 1b for preventing malfunction at power-on of an input power supply voltage VDD includes a first detection circuit 10, a counter circuit 12b, and a control circuit 14b. The first detection circuit 10 generates a POR detection signal Spord based on the power supply voltage VDD. The first detection circuit 10 generates the POR detection signal Spord having a first value for a first time interval Td1 based on detection of power-on of the power supply voltage VDD, and generates the POR detection signal Spord having a second value after the first time interval Td1 has elapsed. The counter circuit 12b is initialized based on the POR detection signal Spord having the first value, and measures a second time interval TI1 based on the POR detection signal Spord having the second value. The control circuit 14b is configured to hold a first switch 3 for controlling discharging of the secondary battery 2 that outputs the power supply voltage VDD and a second switch 4 for controlling charging of the secondary battery 2, in respective predetermined initial states during the first time interval Td1 and the second time interval TI1. After releasing each of the first switch 3 and the second switch 4 from being held in the predetermined initial state, the control circuit 14b detects an abnormality in charging or discharging of the secondary battery 2, and turns off the first switch 3 or the second switch 4 after a third time interval Td4 has elapsed. The charge and discharge control circuit 1b further includes an abnormality detection circuit 15, 16 that generates an abnormality detection signal Sod, Ssd having a sixth value when detecting an abnormality related to charging or discharging of the secondary battery 2. After releasing each of the first switch 3 and the second switch 4 from being held in the predetermined initial state, the control circuit 14b causes the counter circuit 12b to measure the third time interval Td4 based on the abnormality detection signal Sod, Ssd having the sixth value. The control circuit 14b turns off the first switch 3 or the second switch 4 after the third time interval Td4 has elapsed.

With this configuration, the charge and discharge control circuit 1b can operate to protect the secondary battery 2 when an abnormality occurs after the power supply voltage VDD has stabilized, while preventing malfunction of the protection function of the charge and discharge control circuit 1b for the secondary battery 2, irrespective of voltage changes at power-on of the power supply voltage VDD. Furthermore, the charge and discharge control circuit 1b can count the second time interval TI1 and the third time interval Td4 using the counter circuit 12b.

The abnormality detection circuit includes an overdischarge detection circuit 15 that generates an overdischarge detection signal Sod as the abnormality detection signal. When the overdischarge detection circuit 15 detects that the power supply voltage VDD is less than a predetermined threshold value Vod, the overdischarge detection circuit 15 detects an abnormality in the discharge of the secondary battery 2. The control circuit 14b turns off the first switch 3 after the third time interval Td4 has elapsed. With this configuration, when the charge and discharge control circuit 1b detects an abnormality related to overdischarge after the power supply voltage VDD has stabilized, the charge and discharge control circuit 1b can operate to prevent the overdischarge.

A minimum operating voltage of the counter circuit 12b is greater than a minimum operating voltage of the logic circuit included in the charge and discharge control circuit 1b and less than the predetermined threshold value Vod. With this configuration, the counter circuit 12b can operate even if the power supply voltage VDD is less than the predetermined threshold value.

### Third Embodiment

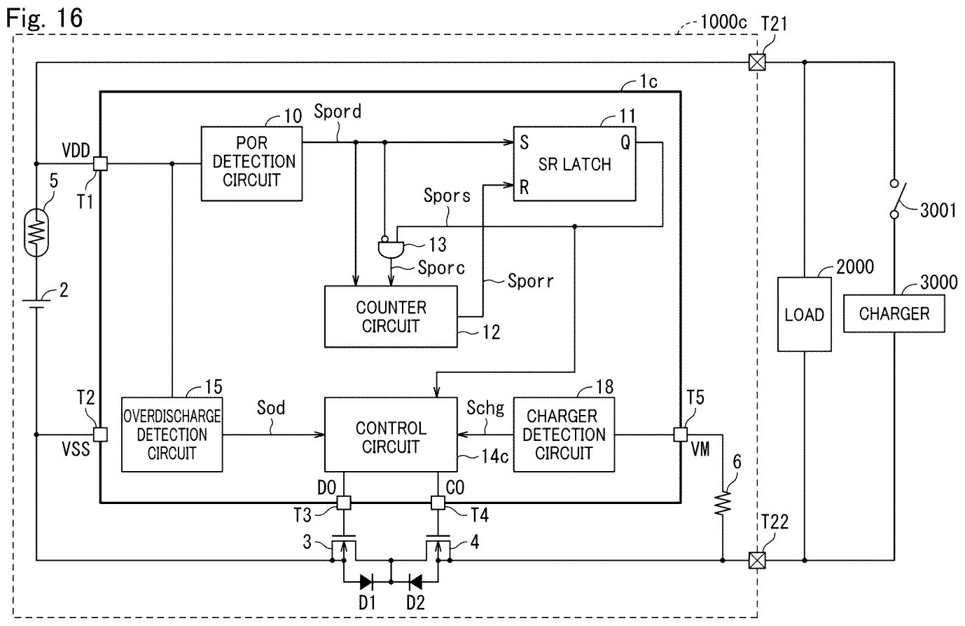

A battery device 1000c according to a third embodiment of the present disclosure will be described with reference to FIG. 16.

In recent years, in order to address the risk for fire accidents of secondary batteries in the market, technologies have been employed in which a plurality of protection devices are provided in a battery device having a secondary battery so as to provide a plurality of protection for the battery device. Such battery devices may, for example, have two charge and discharge control circuits as protection devices to provide dual protection for the battery device. Furthermore, a PTC thermistor, whose resistance increases with increasing temperature, may be used as a protection device. The PTC thermistor is connected in series with the secondary battery, and the battery device is configured to have a function to shut off charging and discharging by utilizing the increase in the PTC thermistor's resistance at high temperatures. In such a battery device, if the circuit is connected in the following order; a secondary battery; a first protection device; a second protection device; and a load, when the first protection device operates and opens the discharge path to the subsequent circuit, the power supply voltage supplied to the second protection device is lost. This opening of the discharge path may include a drop in the power supply voltage due to the increase in the resistance of the PTC thermistor. When the opening of the discharge path in the first protection device is subsequently released, the second protection device may exhibit behavior similar to that at power-on of the power supply voltage supplied to the second protection device at the time of such release. If discharge is resumed immediately after this behavior occurs, the first protection device may operate to open the discharge path again, which is dangerous. Therefore, it may be preferable for the charge and discharge control circuit, which is the second protection device connected closer to the load than the first protection device, to operate in a state that prohibits discharge as an initial state when the power supply rises, in order to prevent the resumption of discharge in a dangerous state.

The charge and discharge control circuit according to the third embodiment is configured to operate in the initialization mode for a certain time interval from power-on of the power supply to the charge and discharge control circuit, maintain the discharge control transistor in the open state in the initialization mode, and start up in a state in which discharge is prohibited. The charge and discharge control circuit according to the third embodiment maintains the discharge control transistor in the open state even if a signal to turn on the discharge control transistor is generated during operation in the initialization mode, thereby prohibiting discharge during power up. Therefore, the charge and discharge control circuit according to the third embodiment can maintain the prohibition of discharge for a certain timer interval from power-on of the power supply, even if a signal to permit discharge is generated due to a malfunction. Furthermore, in a battery device using the charge and discharge control circuit according to the third embodiment as the second protection device, when the first protection device opens the discharge path and then the opening is released, the second protection device starts up in a state in which discharge is prohibited and maintains the state in which discharge is prohibited for a certain time interval from the release. Therefore, the charge and discharge control circuit according to the third embodiment can prevent discharge from the power supply at power-on of the power supply to the charge and discharge control circuit. Furthermore, a battery device having the charge and discharge control circuit of the third embodiment as the second protection device can prevent resumption of discharge via the second protection device in a dangerous state after the discharge path is released from opening by the first protection device as described above.

FIG. 16 is a schematic diagram of the battery device 1000c according to the third embodiment of the present disclosure. The battery device 1000c includes a charge and discharge control circuit 1c instead of the charge and discharge control circuit 1 in the first embodiment. The battery device 1000c also includes the PTC thermistor S and a resistor 6. The battery device 1000c can be further connected to a charger 3000 via the external positive terminal T21 and the external negative terminal T22.

In the battery device 1000c, the PTC thermistor 5 is provided between the secondary battery 2 and the connection point between the positive power supply terminal T1 and the external positive terminal T21. The resistor 6 is provided between the external negative electrode voltage input terminal TS and the connection point between the external negative terminal T22 and the source of the charge control transistor 4. The resistance of the PTC thermistor 5 increases as the temperature of the PTC thermistor S increases. Therefore, the positive power supply voltage VDD at the positive power supply terminal T1 decreases as the temperature of the PTC thermistor 5 increases.

The charger 3000 can be physically connected to or disconnected from the battery device 1000c, or electrically connected or disconnected via a switch. This is illustrated in FIG. 16 using a switch 3001. When the charger 3000 is connected to the battery device 1000c, the external positive terminal T21 is connected to the external negative terminal T22 via the switch 3001 and the charger 3000.

The charge and discharge control circuit 1c includes a control circuit 14c and a charger detection circuit 18 instead of the control circuit 14 and the short-circuit detection circuit 16 in the first embodiment. The charge and discharge control circuit 1c according to the third embodiment is configured to operate in the overdischarge protection mode at power-on of the positive power supply voltage VDD. That is, the charge and discharge control circuit 1c according to the third embodiment is configured to control the discharge control transistor 3 to the open state at power-on of the positive power supply voltage VDD.

The charger detection circuit 18 receives the external negative voltage VM, generates a charger connection signal Schg based on the external negative voltage VM and outputs the signal Schg to the control circuit 14c. When the charger detection circuit 18 detects that the external negative voltage VM is less than a predetermined charger detection voltage Vchg, the charger detection circuit 18 generates the charger connection signal Schg having a high level. When the charger detection circuit 18 detects that the external negative voltage VM is greater than or equal to the predetermined charger detection voltage Vchg, the charger detection circuit 18 generates the charger connection signal Schg having a low level. For example, when the switch 3001 is turned on (i.e., when a charger is connected to the battery device 1000c), the voltage at the external negative terminal T22 and the external negative voltage VM are pulled down to approximately the negative power supply voltage VSS based on the voltage of the charger 3000. Therefore, when the switch 3001 is turned on (i.e., when the charger 3000 is connected to the battery device 1000c), the charger detection circuit 18 generates the charger connection signal Schg having a high level. In this way, the charger detection circuit 18 and the control circuit 14c can detect the connection of the charger 3000 to the battery device 1000c based on the external negative voltage VM.

When the control circuit 14c detects the generation of the charger connection signal Schg having a high level while operating in the overdischarge protection mode, the control circuit 14c transitions from the overdischarge protection mode to the normal mode, and generates the discharge control signal DO having a high level to turn on the discharge control transistor 3. In other words, the charge and discharge control circuit 1c is normally configured to terminate the overdischarge protection mode and permit discharge when the charger 3000 is connected.

The control circuit 14c according to the third embodiment is configured to operate in an initialization mode for a certain time interval from power-on of the positive power supply voltage VDD, thereby maintaining the discharge control transistor 3 and the charge control transistor 4 in their respective predetermined initial states. In the charge and discharge control circuit 1c according to the third embodiment, the predetermined initial state of the discharge control transistor 3 is the open state. As a result, when the control circuit 14c transitions to the initialization mode, the control circuit 14c can maintain the discharge control transistor 3 in the open state, similar to the overdischarge protection mode. In other words, the control circuit 14c can transition to the overdischarge protection mode as the initialization mode. In the charge and discharge control circuit 1e according to the third embodiment, the predetermined initial state of the charge control transistor 4 may be the open state or the conductive state. The control circuit 14c maintains the initialization mode even if control circuit 14c receives the abnormality detection signal or the charger connection signal Schg having a high level during the initialization mode. Therefore, the control circuit 14c according to the third embodiment can maintain the discharge control transistor 3 in the open state even if it erroneously detects the connection of the charger 3000 during a certain time interval from power-on of the positive power supply voltage VDD.

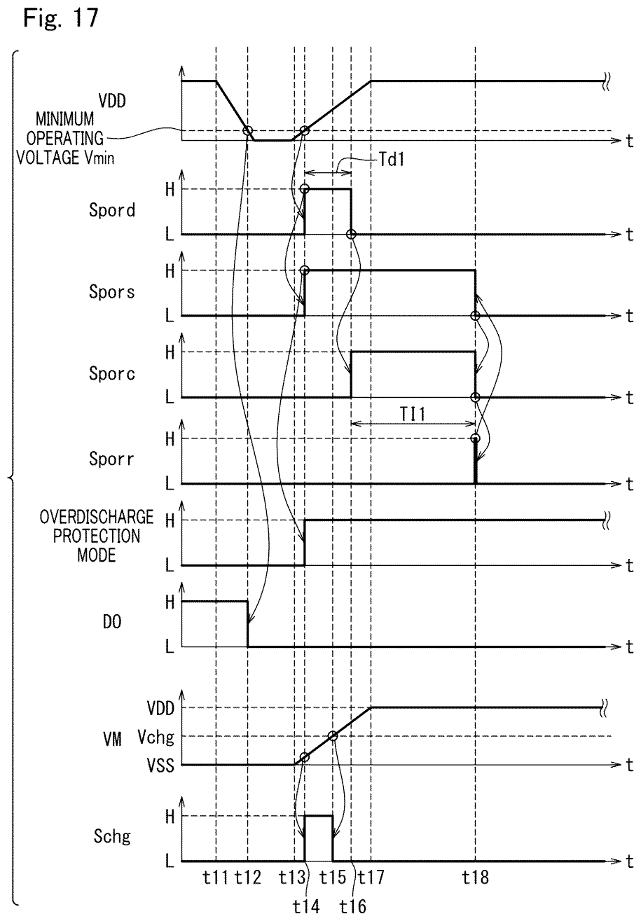

The operation of the charge and discharge control circuit 1c according to the third embodiment will be described. FIG. 17 is a timing chart illustrating an example of the operation of the charge and discharge control circuit 1c. The example shown in FIG. 17 shows a timing chart relating to erroneous detection of connection of the charger 3000 during the initialization mode. The horizontal axis of FIG. 17 represents time. The vertical axes of FIG. 17 represent the positive power supply voltage VDD, the level of the POR detection signal Spord, the level of the POR state signal Spors, the level of the POR duration measurement request Sporc, the level of the POR release signal Sporr, the state of the overdischarge protection mode, the level of the discharge control signal DO, the external negative voltage VM, and the level of the charger connection signal Schg, respectively.

At time t11, when the temperature of the PTC thermistor 5 rises, the resistance of the PTC thermistor S increases and the positive power supply voltage VDD decreases. Before time t11 and from time t11 to time 112, the control circuit 14c operates, for example, in the normal mode, generates the discharge control signal DO having a high level and keeps the discharge control transistor 3 in the conductive state. At time t12, when the positive power supply voltage VDD falls below the minimum operating voltage Vmin of the charge and discharge control circuit 1c, the control circuit 14c can no longer maintain the discharge control signal DO having a high level, so that the discharge control signal DO changes to a low level, and the discharge control transistor 3 is turned off.

At time t13, when the temperature of PTC thermistor 5 drops and the resistance decreases, the positive power supply voltage VDD rises. Furthermore, while discharge control transistor 3 is in the open state, the voltage at the external negative terminal T22 and external negative voltage VM are pulled up to the same potential as the voltage at the external positive terminal T21 via the load 2000, and therefore rise along with the positive power supply voltage VDD. When the positive power supply voltage VDD exceeds the minimum operating voltage Vmin at time t14, the POR detection circuit 10, the SR latch 11, the counter circuit 12, and the AND circuit 13 operate from time t14 to time t18 in the same manner as the circuits at time t1 to time t3 in the timing chart shown in FIG. 7.

At time t14, when the control circuit 14c receives the POR state signal Spors having a high level, the control circuit 14c operates in the initialization mode. The control circuit 14c operates in the initialization mode from time t14 until the delay time Td1 and the POR duration TI1 described later have elapsed, and maintains the discharge control transistor 3 in the open state. As described above, in the charge and discharge control circuit 1c according to the third embodiment, the initialization mode corresponds to the overdischarge protection mode. Therefore, when the control circuit 14c receives the POR state signal Spors having a high level, the control circuit 14c operates in the overdischarge protection mode. Furthermore, because the external negative voltage VM is less than the charger detection voltage Vchg at time t14, the charger detection circuit 18 generates the charger connection signal Schg having a high level and outputs the signal Schg to the control circuit 14c. In other words, the charger detection circuit 18 erroneously detects the connection of the charger 3000.

Because the control circuit 14c operates in the initialization mode, i.e., the overdischarge protection mode, even if the control circuit 14c receives the charger connection signal Schg having a high level, the control circuit 14c does not return from the overdischarge protection mode and continues to operate in the overdischarge protection mode. Therefore, the control circuit 14c maintains the discharge control signal DO having a low level and holds the discharge control transistor 3 in the open state as the predetermined initial state.

At time t15, when the charger detection circuit 18 detects that the external negative voltage VM is greater than or equal to the charger detection voltage Vchg, the charger detection circuit 18 generates the charger connection signal Schg having a low level and outputs the signal Schg to the control circuit 14c. In other words, the charger detection circuit 18 stops erroneously detecting the connection of the charger 3000. At time t16, which is the delay time Td1 after time t14, the control circuit 14c generates the POR detection signal Spord having a low level, and the counter circuit 12 measures the POR duration TI1. The delay time Td1 may be shorter than the time interval from time t14 to time t15.

At time t17, the positive power supply voltage VDD rises to the same voltage as before time t11. Similarly, the external negative voltage VM rises to a voltage corresponding to the positive power supply voltage VDD at time t17. At time t18, which is the POR duration TI1 after time t16, the control circuit 14c terminates operation in the initialization mode. At this time, because the charger connection signal Schg has a low level, the control circuit 14c maintains the overdischarge protection mode. Therefore, the charge and discharge control circuit 1c can maintain a state in which discharge from the secondary battery 2 is prohibited when the positive power supply voltage VDD rises.

Thus, the charge and discharge control circuit 1c according to the third embodiment can start up while maintaining the discharge control transistor 3 in the open state and prohibiting discharge at rise of the power supply. Because the charge and discharge control circuit 1c operates in the initialization mode and maintains the discharge control transistor 3 in the open state for a certain time interval after power-on, even if a signal to turn on the discharge control transistor 3 is generated due to a malfunction, the charge and discharge control circuit 1c does not operate based on the signal and continues to maintain the discharge control transistor 3 in the open state. Therefore, the charge and discharge control circuit 1c can prevent malfunction during a certain time interval after power-on, and can prevent discharge from a preceding circuit to a succeeding load at power-on.

The charge and discharge control circuit 1c according to the third embodiment of the present disclosure can achieve the following effects.

The charge and discharge control circuit 1c for preventing malfunction at power-on of an input power supply voltage VDD includes a first detection circuit 10, a counter circuit 12, and a control circuit 14c. The first detection circuit 10 generates a POR detection signal Spord based on the power supply voltage VDD. The first detection circuit 10 generates the POR detection signal Spord having a first value for a first time interval Td1 based on detection of power-on of the power supply voltage VDD, and generates the POR detection signal Spord having a second value after the first time interval Td1 has elapsed. The counter circuit 12 is initialized based on the POR detection signal Spord having the first value and measures a second time interval TI1 based on the POR detection signal Spord having the second value. The control circuit 14c is configured to hold a first switch 3 for controlling discharging of the secondary battery 2 that outputs the power supply voltage VDD and a second switch 4 for controlling charging of the secondary battery 2, in respective predetermined initial states during the first time interval Td1 and the second time interval TI1. The predetermined initial state of the first switch 3 is an open state, and the control circuit 14c is configured to hold the first switch 3 in the open state during the first time interval Td1 and the second time interval TI1.

With this configuration, the charge and discharge control circuit 1c holds the first switch 3 in the open state during the first time interval Td1 and the second time interval TI1 at power-on of the power supply voltage VDD. Thus, the charge and discharge control circuit 1c can hold the first switch in the open state even if a signal to turn on the first switch is generated due to a malfunction during the first time interval Td1 and the second time interval TI1. Therefore, the charge and discharge control circuit 1c can prevent discharge from the secondary battery 2 due to the malfunction at power-on of the power supply voltage VDD.

### Modifications

In the above embodiment, the state holding circuit 11 is an SR latch, but the state holding circuit 11 is not limited to the SR latch. The state holding circuit 11 may be a circuit capable of holding a signal level, such as a D flip-flop circuit or other latch circuit. Instead of including the SR latch 11, the charge and discharge control circuits 1, 1b, and lc may be configured to include a circuit that generates a signal having a predetermined level from occurrence of the POR detection signal Spord having a low level until the counter circuit 12, or 12b measures the POR duration TI1.

In the above embodiments, the charge and discharge control circuits 1, 1b, and 1c are configured to protect against abnormalities such as overdischarge and short-circuit, but the protection provided by the charge and discharge control circuits 1, 1b, and le is not limited to these abnormalities. For example, the charge and discharge control circuits 1, 1b, and le may be configured to protect against overcharging, discharge overcurrent, charging overcurrent, high temperature, and low temperature. Furthermore, the charge and discharge control circuits 1, 1b, and 1c may be configured to have a state control function based on an external input.

In the above embodiments, the charge and discharge control circuits 1, 1b, and 1c initialize the control circuits 14, 14b, and 14c based on the POR state signal Spors, but may also be configured to initialize the abnormality detection circuit 15 or 16 or the charger detection circuit 18 based on the POR state signal Spors so as not to output the abnormality detection signal Sod or Ssd or the charger connection signal Schg. Also, the charge and discharge control circuits 1, 1b, and 1c may be configured to initialize the control circuit 14, 14b, or 14c based on the POR detection signal Spord and the POR state signal Spors.

In the above embodiments, the charge and discharge control circuits 1, 1b, and 1c are configured to operate on the low side, but may also be configured to operate on the high side. In this case, the charge and discharge control circuits are configured to have an external positive electrode voltage input terminal connected to the external positive terminal T21, instead of the external negative electrode voltage input terminal T5 connected to the external negative terminal T22. The battery device is also configured to have charge and discharge control transistors connected between the positive terminal of the secondary battery 2 and the external positive terminal T21, instead of the charge and discharge control transistors 3 and 4 connected between the negative terminal of the secondary battery 2 and the external negative terminal T22.

In the second embodiment described above, the control circuit 14b generates the abnormality estimation signal Sfe based on the abnormality detection signal such as the overdischarge detection signal Sod or the short-circuit detection signal Ssd. The counter circuit 12b measures the delay time Td4 based on the POR state signal Spors and the abnormality estimation signal Sfe. However, the charge and discharge control circuit 1b is not limited to the configuration. The control circuit 14b may be configured to generate the delay time measurement request Sdc based on the POR state signal Spors and the abnormality detection signal and output the request Sdc to the counter circuit 12b. For example, the control circuit 14b may be configured to generate the delay time measurement request Sdc having a high level when the POR state signal Spors has a low level and the abnormality detection signal has a high level, and to generate the delay time measurement request Sdc having a low level otherwise.

### Summary of Aspects

As apparent from the above description, the present disclosure includes the following aspects. In the following, reference numerals are given in parentheses only to clearly indicate the correspondence with the embodiments.

### Aspect 1

A charge and discharge control circuit (1, 1b, 1c) according to the present disclosure is a charge and discharge control circuit for preventing malfunction at power-on of an input power supply voltage (VDD), comprising:
a first detection circuit (10) that generates a POR detection signal (Spord) based on the power supply voltage, the first detection circuit generating the POR detection signal having a first value for a first time interval (Td1) based on detection of power-on of the power supply voltage, and generating the POR detection signal having a second value after the first time interval has elapsed;
a counter circuit (12, 12b) that is initialized based on the POR detection signal having the first value, the counter circuit measuring a second time interval (TI1) based on the POR detection signal having the second value; and
a control circuit (14, 14b, 14c) configured to hold a first switch (3) for controlling discharging of a secondary battery (2) that outputs the power supply voltage and a second switch (4) for controlling charging of the secondary battery, in respective predetermined initial states during the first time interval and the second time interval.

### Aspect 2

The charge and discharge control circuit (1, 1b, 1c) of aspect 1 further comprises a state holding circuit (11) that generates a POR state signal (Spors) based on the POR detection signal (Spord),
wherein the state holding circuit generates the POR state signal having a third value based on the POR detection signal having the first value, holds the POR state signal at the third value during the first time interval (Td1) and the second time interval (TI1), and generates the POR state signal having a fourth value after the second time interval has elapsed, and
wherein the control circuit (14, 14b, 14c) releases each of the first switch (3) and the second switch (4) from being held in the predetermined initial state based on the POR state signal having the fourth value.

### Aspect 3

In the charge and discharge control circuit (1, 1b, 1c) of aspect 2, the state holding circuit (11) latches the POR state signal (Spors) to the third value based on the POR detection signal (Spord) having the first value, and releases the latching after the second time interval (TI1) has elapsed.

### Aspect 4

In the charge and discharge control circuit (1, 1b, 1c) of aspect 2 or 3, after the second time interval (TI1) has elapsed, the counter circuit (12, 12b) generates a POR release signal (Sporr) having a fifth value and outputs the generated POR release signal to the state holding circuit (11).

### Aspect 5

In the charge and discharge control circuit (1, 1b) of any one of aspects 1 to 4, the control circuit (14, 14b) detects an abnormality in charging or discharging of the secondary battery (2) after releasing each of the first switch (3) and the second switch (4) from being held in the predetermined initial state, and turns off the first switch or the second switch after a third time interval (Td2, Td3, Td4) has elapsed.

### Aspect 6

The charge and discharge control circuit (1b) of aspect 5 further comprises an abnormality detection circuit (15, 16) that generates an abnormality detection signal (Sod, Ssd) having a sixth value when detecting an abnormality related to charging or discharging of the secondary battery (2),
wherein, after releasing each of the first switch (3) and the second switch (4) from being held in the predetermined initial state, the control circuit (14b) causes the counter circuit (12b) to measure the third time interval (Td4) based on the abnormality detection signal having the sixth value, and, after the third time interval has elapsed, the control circuit turns off the first switch or the second switch.

### Aspect 7

In the charge and discharge control circuit (1b) of aspect 6, the abnormality detection circuit comprises an overdischarge detection circuit (15) that generates an overdischarge detection signal (Sod) as the abnormality detection signal,
wherein, when the overdischarge detection circuit detects that the power supply voltage (VDD) is less than a predetermined threshold value (Vod), the overdischarge detection circuit detects an abnormality in the discharge of the secondary battery (2), and
wherein, after the third time interval (Td4) has elapsed, the control circuit (14b) turns off the first switch (3).

### Aspect 8

In the charge and discharge control circuit (1b) of aspect 7, a minimum operating voltage of the counter circuit (12b) is greater than a minimum operating voltage of a logic circuit included in the charge and discharge control circuit and less than the predetermined threshold value (Vod).

### Aspect 9

In the charge and discharge control circuit (1c) of any one of aspects 1 to 4, the predetermined initial state of the first switch (3) is an open state, and the control circuit (14c) is configured to hold the first switch in the open state during the first time interval (Td1) and the second time interval (TI1).

### Aspect 10

In the charge and discharge control circuit (1, 1b, 1c) of any one of aspects 1 to 9, the first detection circuit (10) generates the POR detection signal (Spord) having the first value based on the rise of the power supply voltage (VDD), and generates the POR detection signal having the second value after the first time interval (Td1) from the detection of power-on of the power supply voltage.

### Aspect 11

A battery device (1000, 1000b, 1000c) according to the present disclosure includes:
a charge and discharge control circuit (1, 1b, 1c) according to any one of aspects 1 to 10;
a secondary battery (2);
a first switch (3) for controlling discharging of the secondary battery, and
a second switch (4) for controlling charging of the secondary battery

### Aspect 12

A charge and discharge control method according to the present disclosure is a charge and discharge control method for preventing malfunction at power-on of an input power supply voltage (VDD), comprising:
generating, by a detection circuit (10) that generates a POR detection signal (Spord) based on the power supply voltage, the POR detection signal having a first value for a first time interval (Td1) based on detection of power-on of the power supply voltage, and generating the POR detection signal having a second value after the first time interval has elapsed;
measuring, by a counter circuit (12, 12b), a second time interval (TI1) based on the POR detection signal having the second value, the counter circuit being initialized based on the POR detection signal having the first value; and
holding, by a control circuit (14, 14b, 14c), a first switch (3) for controlling discharging of a secondary battery (2) that outputs the power supply voltage and a second switch (4) for controlling charging of the secondary battery, in respective predetermined initial states during the first time interval and the second time interval.

In the present specification, the terms “first”, “second”, and the like are only used for description, and should not be understood as clearly indicating or implying relative importance or a rank of a technical feature. Features limited to “first” and “second” are intended to clearly indicate or imply the inclusion of one or more such features.

According to the present disclosure, it is possible to provide a charge and discharge control circuit, a charge and discharge control method, and a battery device that suppress malfunction of the protection function for a secondary battery at power-on of the power supply voltage, as compared with conventional techniques. Thus, the present disclosure can be suitably used in this type of industrial field

What is claimed is

1. A charge and discharge control circuit for preventing malfunction at power-on of an input power supply voltage, comprising:
a first detection circuit that generates a POR detection signal based on the power supply voltage, the first detection circuit generating the POR detection signal having a first value for a first time interval based on detection of power-on of the power supply voltage, and generating the POR detection signal having a second value after the first time interval has elapsed;
a counter circuit that is initialized based on the POR detection signal having the first value, the counter circuit measuring a second time interval based on the POR. detection signal having the second value; and
a control circuit configured to hold a first switch for controlling discharging of a secondary battery that outputs the power supply voltage and a second switch for controlling charging of the secondary battery, in respective predetermined initial states during the first time interval and the second time interval.

2. The charge and discharge control circuit as claimed in claim 1, further comprising a state holding circuit that generates a POR state signal based on the POR. detection signal,
wherein the state holding circuit generates the POR state signal having a third value based on the POR detection signal having the first value, holds the POR state signal at the third value during the first time interval and the second time interval, and generates the POR state signal having a fourth value after the second time interval has elapsed, and
wherein the control circuit releases each of the first switch and the second switch from being held in the predetermined initial state based on the POR state signal having the fourth value.

3. The charge and discharge control circuit as claimed in claim 2, wherein the state holding circuit latches the POR state signal to the third value based on the POR. detection signal having the first value, and releases the latching after the second time interval has elapsed.

4. The charge and discharge control circuit as claimed in claim 2, wherein, after the second time interval has elapsed, the counter circuit generates a POR release signal having a fifth value and outputs the generated POR release signal to the state holding circuit.

5. The charge and discharge control circuit as claimed in claim 1, wherein the control circuit detects an abnormality in charging or discharging of the secondary battery after releasing each of the first switch and the second switch from being held in the predetermined initial state, and turns off the first switch or the second switch after a third time interval has elapsed.

6. The charge and discharge control circuit as claimed in claim 5, further comprising an abnormality detection circuit that generates an abnormality detection signal having a sixth value when detecting an abnormality related to charging or discharging of the secondary battery,
wherein, after releasing each of the first switch and the second switch from being held in the predetermined initial state, the control circuit causes the counter circuit to measure the third time interval based on the abnormality detection signal having the sixth value, and, after the third time interval has elapsed, the control circuit turns off the first switch or the second switch.

7. The charge and discharge control circuit as claimed in claim 6,
wherein the abnormality detection circuit comprises an overdischarge detection circuit that generates an overdischarge detection signal as the abnormality detection signal,
wherein, when the overdischarge detection circuit detects that the power supply voltage is less than a predetermined threshold value, the overdischarge detection circuit detects an abnormality related to discharging of the secondary battery, and
wherein, after the third time interval has elapsed, the control circuit turns off the first switch.

8. The charge and discharge control circuit as claimed in claim 7, wherein a minimum operating voltage of the counter circuit is greater than a minimum operating voltage of a logic circuit included in the charge and discharge control circuit and less than the predetermined threshold value.

9. The charge and discharge control circuit as claimed in claim 1, wherein the predetermined initial state of the first switch is an open state, and the control circuit is configured to hold the first switch in the open state during the first time interval and the second time interval,

10. The charge and discharge control circuit as claimed in claim 1, wherein the first detection circuit generates the POR detection signal having the first value based on the rise of the power supply voltage, and generates the POR detection signal having the second value after the first time interval from the detection of power-on of the power supply voltage.

11. A battery device comprising:
a charge and discharge control circuit as claimed in claim 1;
a secondary battery;
a first switch for controlling discharging of the secondary battery; and
a second switch for controlling charging of the secondary battery.

12. A charge and discharge control method for preventing malfunction at power-on of an input power supply voltage, comprising:
generating, by a detection circuit that generates a POR detection signal based on the power supply voltage, the POR detection signal having a first value for a first time interval when detecting power-on of the power supply voltage, and generating the POR detection signal having a second value after the first time interval has elapsed;
measuring, by a counter circuit, a second time interval based on the POR detection signal having the second value, the counter circuit being initialized based on the POR detection signal having the first value; and
holding, by a control circuit, a first switch for controlling discharging of a secondary battery that outputs the power supply voltage and a second switch for controlling charging of the secondary battery, in respective predetermined initial states during the first time interval and the second time interval.
